(19) United States
(12) Patent Application Publication
(10) Pub. No.: US 2024/0362575 A1
(43) Pub. Date: Oct. 31, 2024

(54) Module for Determining a Shipping Option

(71) Applicants: Dennis Kamb, Rösrath (DE); Ralf Hormann, Bonn (DE); Christoph Dautz, Bonn (DE)

(72) Inventors: Dennis Kamb, Rösrath (DE); Ralf Hormann, Bonn (DE); Christoph Dautz, Bonn (DE)

(73) Assignee: Deutsche Post AG, Bonn (DE)

(21) Appl. No.: 18/637,561

(22) Filed: Apr. 17, 2024

(30) Foreign Application Priority Data
Apr. 26, 2023 (DE) 10 2023 110 656.2

(51) Int. Cl. G06Q 10/0834; G07B 17/00

(52) U.S. Cl. CPC G06Q 10/0834; G07B 17/00467; G07B 17/00508; G07B 17/00661; G07B 2017/00685; G07B 2017/00701

(57) ABSTRACT

A method is disclosed. The method includes causing the opening of a lockable measuring module. The method includes obtaining at least one measurement parameter of a shipment deposited in the measuring module. The method includes providing, at least partially based on the obtained at least one measurement parameter, measurement information. The measurement information represents at least one weight and/or size of the shipment deposited in the measuring module. The at least one shipping option for shipping the shipment is determined at least partially based on the provided measurement information.

### CROSS-REFERENCE TO RELATED PATENT APPLICATIONS

This patent application claims priority to German Application No. 10 2023 110 656.2, filed Apr. 26, 2023, the entire teachings and disclosures of which are incorporated herein by reference thereto.

### FIELD OF THE INVENTION

Exemplary embodiments of the present disclosure relate to methods, apparatuses, systems and computer programs for providing measurement information, wherein at least one shipping option for shipping a shipment is determined at least partially based on the provided measurement information.

### BACKGROUND OF THE INVENTION

Compartment installations are used diversely in the form of lockbox or parcel compartment installations, for example. One example of a compartment installation is a parcel station, for example, which a user may cause to allow delivery for the purpose of receiving or shipping post shipments. Such shipping usually comprises storing a shipment to be shipped in the compartment installation, wherein the user for example deposits the shipment in a compartment of the compartment installation and the compartment is subsequently locked. During this process of storing the shipment, it may be disadvantageous that one or more properties of the shipment and for example possible user preferences on which the shipping of the shipment may depend, for example, are not taken into account.

### SUMMARY OF THE INVENTION

Therefore, the problem addressed by the invention disclosed in the present case is, inter alia, that of providing measurement information, for example in the context of storing a shipment in a compartment installation, wherein at least one shipping option for shipping the shipment is determined at least partially based on the provided measurement information.

According to a first exemplary aspect of the present disclosure, a method is disclosed, comprising the following:
causing the opening of a lockable measuring module;
obtaining at least one measurement parameter of a shipment deposited in the measuring module; and
providing, at least partially based on the obtained at least one measurement parameter, measurement information, wherein the measurement information represents at least one weight and/or size of the shipment deposited in the measuring module, and wherein at least one shipping option for shipping the shipment is determined at least partially based on the provided measurement information.

For example, the method according to the first aspect may be carried out at least partially or completely by a control unit of the measuring module.

According to a second exemplary aspect of the present disclosure, a method is disclosed, comprising the following:
obtaining at least one measurement information, wherein the measurement information represents at least one weight and/or size of a shipment deposited in a lockable measuring module; and
determining, at least partially based on the obtained measurement information, at least one shipping option for shipping the shipment.

For example, the method according to the second aspect may be carried out at least partially or completely by a control unit of a compartment installation or by a backend server.

According to each of these aspects of the present disclosure, the following are furthermore disclosed in each case:
A computer program, comprising program instructions that cause a processor to perform and/or to control the method according to the respective aspect of the invention when the computer program runs on the processor. In this specification, a processor should be understood to mean, inter alia, control units, microprocessors, microcontrol units such as microcontrollers, digital signal processors (DSP), application-specific integrated circuits (ASICs) or field programmable gate arrays (FPGAs). Here either all the steps of the method may be controlled, or all the steps of the method may be performed, or one or more steps may be controlled and one or more steps may be performed. The computer program may be distributable for example via a network such as the Internet, a telephone or mobile radio network and/or a local network. The computer program may be at least partially software and/or firmware of a processor. It may equally be implemented at least partially as hardware. The computer program may be stored for example on a computer-readable storage medium, e.g. a magnetic, electrical, optical and/or other type of storage medium. The storage medium may be for example part of the processor, for example a (nonvolatile or volatile) program memory of the processor or a part thereof. The storage medium may be for example a substantive or physical storage medium.
An apparatus, configured to perform and/or control the method according to the respective aspect of the invention or comprising respective means for performing and/or controlling the steps of the method according to the respective aspect of the invention. Here either all the steps of the method may be controlled, or all the steps of the method may be performed, or one or more steps may be controlled and one or more steps may be performed. One or more of the means may also be implemented and/or controlled by the same unit. By way of example, one or more of the means may be formed by one or more processors.
An apparatus, comprising at least one processor and at least one memory that includes program code, wherein the memory and the program code are configured to cause an apparatus having the at least one processor to perform and/or control at least the method according to the respective aspect of the invention. Here either all the steps of the method may be controlled, or all the steps of the method may be performed, or one or more steps may be controlled and one or more steps may be performed.

A measuring module comprises for example at least one compartment configured to receive at least one shipment (e.g. a letter, parcel or package). Such a compartment of the measuring module is lockable (e.g. closable by lock), for example by means of a door or shutter. For example, the compartment of the measuring module is a substantially parallelepipedal receiving container provided with doors or shutters on one or more sides.

Lockability of the measuring module may be afforded, for example, by the compartment of the measuring module being provided with a lock in order to be able to control access to the compartment by users. Such a lock may be arranged for example in or on the compartment, for example on a door (e.g. also in the form of a shutter) of the compartment. If the lock is not arranged on the door (that is to say is arranged on a lateral wall of the compartment, for example), it interacts with the door, for example, by virtue of a bolt being introduced into an opening in the door and pulled out again, for example. The lock of a compartment may return to a locked position as standard, for example, and then be actuable only for unlocking purposes, for example. After the lock has been unlocked, it is then possible for the door of the compartment to be opened, for example. Since the lock automatically returns to the locked position, locking of the compartment may be achieved by closing the door, for example by virtue of a catch function of the lock being utilized when closing the door.

For example, the compartment of the measuring module may be either open or closed. In the open state of the compartment, the lock of the compartment is unlocked. The door of the compartment may then be opened by a person without force being applied, for example, or stands open. In the closed state of the compartment, by contrast, the lock of the compartment is locked. The door of the compartment may then no longer be opened by a person who is not authorized for opening without force being applied, for example.

The lock of the compartment of the measuring module is controllable, for example, in particular in electronic form. In particular, at least the process of closing (e.g. locking) and/or opening (e.g. unlocking) of the lock may be controlled (e.g. caused). The lock of a compartment may be controlled for example by a lock control unit comprised by the measuring module, wherein the lock control unit of the measuring module is controlled for example by a superordinate control unit of the measuring module. Such a control unit of the measuring module may for example not just actuate the lock control unit but additionally ascertain whether obtained access information authorizes access to the compartment, and accordingly grant access to the compartment (e.g. by unlocking the door of the compartment) or deny access (e.g. by virtue of the door of the compartment not being unlocked).

Besides at least one compartment and a control unit, for example, the measuring module comprises at least one sensor configured to detect at least one measurement parameter of a shipment deposited in the measuring module (e.g. in the compartment of the measuring module). In particular, the at least one measurement parameter of the deposited shipment is detected while this shipment is located in the measuring module, such that this measurement parameter is assignable to the deposited shipment, for example. In this case, a measurement parameter of a shipment deposited in the measuring module may be understood as a measurement parameter which depends for example on the deposited shipment (e.g. on properties of this shipment) and arises for example as a result of properties of this shipment and/or is influenced by the latter. A measurement parameter of a shipment depends for example on a size (e.g. length, width, depth and/or volume) and/or on a weight of the shipment and results for example from this size and this weight. Consequently, for example (e.g. when processing the measurement parameter e.g. with further information such as e.g. further measurement parameters of the shipment) it is possible to determine the size and/or the weight of the shipment at least partially based on the measurement parameter. For example, a measurement parameter of the shipment represents information about a weight and/or a size of the deposited shipment. A measurement parameter of a shipment may be for example an electrical signal and/or electrically transmitted information which represents a size and/or a weight of the shipment, such that the size and/or the weight of the shipment may be determined at least partially based on the measurement parameter.

In one example, the at least one sensor of the measuring module may be provided by a weight sensor, wherein the weight sensor may be part of an electronic scale arranged in the compartment of the measuring module. By way of example, such a scale is incorporated in the base of the compartment of the measuring module, such that the weight of a shipment is detected when this shipment is located in the compartment of the measuring module. In this example, the detected measurement parameter of the deposited shipment in the form of an electrical signal output by the electronic scale indicates the weight of the deposited shipment.

As an alternative or in addition to a weight sensor, the measuring module may comprise further sensors for detecting a measurement parameter of a shipment. For example, the measuring module comprises one or more optical or optoelectronic sensors which detect information regarding the size of a shipment deposited in the compartment of the measuring module. In this case, by way of example, by means of a light transmitter (e.g. a light-emitting diode or a laser diode) and a light receiver (e.g. a light-sensitive resistor or a photodiode), a light barrier may be realized within the compartment of the measuring module, such that for example an interruption of a light beam of the light barrier indicates a size of a shipment deposited in the compartment. If light transmitter and light receiver are arranged at a specific height in the compartment of the measuring module, for example, an interruption of the light beam indicates for example that a height of the deposited shipment is at least equal to the height at which light transmitter and light receiver are arranged. The measurement parameter of the deposited shipment may for example be a photocurrent of the light receiver and indicate a lower limit of the height of the deposited shipment.

In a further example, the measuring module may comprise one or more cameras which each capture one or more images (e.g. with the image information thereof as exemplary measurement parameters) of a shipment deposited in the compartment of the measuring module, wherein for example an evaluation of the one or more images enables a size of the shipment deposited in the compartment to be determined.

In further examples, the measuring module may comprise further sensors (e.g. magnetic, capacitive and/or inductive sensors) configured to detect a measurement parameter of a shipment deposited in the compartment of the measuring module.

The at least one sensor of the measuring module may be controlled (e.g. supervised or driven) by the control unit of the measuring module, for example. For example, the at least one sensor is connected to the control unit of the measuring module in a wireless or wired manner, such that the control unit may for example cause the at least one sensor (e.g. by means of an electrical signal) to detect a measurement parameter. Furthermore, the at least one sensor may transmit for example a detected measurement parameter (e.g. by means of an electrical signal) to the control unit of the measuring module, wherein the control unit for example processes the obtained measurement parameter and determines measurement information based on the obtained measurement parameter.

Furthermore, it should be understood, for example, that the measuring module (e.g. the compartment, the control unit and/or the at least one sensor of the measuring module) is designed for permanent outdoor use. Accordingly, by way of special protective measures, for example, the measuring module may be configured to withstand for example environmental influences (e.g. weather-related moisture, heat and cold) or vandalism (e.g. malicious damage or manipulation of the measuring module). By way of example, a lock of the compartment of the measuring module may be configured to be particularly secure or a door of the compartment of the measuring module may be configured to allow the compartment to be locked in a watertight manner.

The control unit of the measuring module comprises for example one or more communication interfaces configured for example to transmit measurement information determined by the control unit (e.g. to a mobile device, a control unit of a compartment installation or a backend server). For this purpose, the one or more communication interfaces may be based for example on optical transmission and/or transmission of electrical, magnetic or electromagnetic signals or fields (e.g. Bluetooth, NFC and/or RFID). In alternative or additional examples, communication via a communication interface of the control unit of the measuring module may be based on the Internet Protocol (IP). By way of example, for this purpose, at least one of the communication interface(s) of the control unit of the measuring module is embodied as a local area network (LAN) interface.

For example, besides the features described above, the measuring module may have further equipment features and, by way of example, as described further below, may comprise transport means for transporting a shipment deposited in the compartment of the measuring module into a compartment installation or printing means for printing a shipping labeling on the shipment.

Causing the opening of the lockable measuring module may be understood for example such that opening of the compartment of the measuring module is caused. In this case, the opening of the compartment may comprise for example the unlocking of the previously locked compartment of the measuring module. For the purpose of causing the opening, for example, the control unit of the measuring module may control the lock control unit of the measuring module (e.g. by means of an electrical signal), such that the lock control unit opens a door of the compartment of the measuring module and for this purpose unlocks a lock of the door, for example. In another example, the control unit of the measuring module may open the compartment of the measuring module directly (i.e. without causing) and without the additional use of a lock control unit.

After the opening (e.g. after the unlocking) of the measuring module, for example, a user may deposit a shipment (e.g. a letter, parcel or package) in the opened compartment of the measuring module. This may involve for example a shipment which is shipped in the further course of events and for this purpose is intended to be stored in a compartment installation, for example. After the shipment has been deposited in the measuring module, the user closes the measuring module, for example, such that subsequently a measurement parameter of the shipment deposited in the measuring module may be detected while the measuring module is closed and the shipment is located in the measuring module. In another example, the measuring module may remain open after the shipment has been deposited and during the detecting of a measurement parameter of the shipment.

After the opening of the measuring module and for example after the depositing of a shipment in the opened measuring module, obtaining at least one measurement parameter of the shipment deposited in the measuring module ensues. Obtaining the at least one measurement parameter comprises for example detecting the at least one measurement parameter of the shipment by way of the at least one sensor of the measuring module, wherein the at least one measurement parameter of the shipment is detected by the at least one sensor while the shipment is located in the compartment of the measuring module. After the detecting, the at least one detected measurement parameter is transmitted to the control unit of the measuring module, for example, at which the at least one measurement parameter is obtained (e.g. received) by the control unit. For example, the control unit of the measuring module may cause the detecting of the measurement parameter by way of the actuating of the at least one sensor, such that the latter detects the at least one measurement parameter and transmits it to the control unit.

Providing (e.g. by the control unit of the measuring module) measurement information at least partially based on the obtained at least one measurement parameter should be understood to mean, for example, that measurement information is determined at least partially based on the obtained measurement parameter of the deposited shipment (e.g. by the control unit of the measuring module) and subsequently for example is provided for the transmission and is transmitted. Such a transmission may comprise for example transmitting the measurement information to a control unit of a compartment installation, to a mobile device or to a backend server. Accordingly, the method according to the first aspect may for example comprise determining the measurement information at least partially based on the obtained at least one measurement parameter and alternatively or additionally comprise transmitting the measurement information.

For example, the measurement information is determined at least partially based on the obtained at least one measurement parameter by the measurement information being determined, derived or calculated depending on the at least one measurement parameter. In another example, the measurement information may correspond to the obtained measurement parameter. In a further example, it may be necessary for measurement information to be determined from a plurality of measurement parameters of the deposited shipment.

For example, based on a measurement parameter which is detected with the aid of a weight sensor and which indicates information about a weight of the deposited shipment, measurement information is determined and provided, wherein the measurement information represents a weight of the shipment deposited in the measuring module. In this case, the correspondingly provided measurement information may indicate for example the weight of the shipment in an appropriate unit (e.g. weight 2 kg). In another example, the measurement information indicates that the weight of the shipment is greater or less than a predetermined threshold value (e.g. that the weight of the shipment is greater or less than 2 kg). In another example, based on a measurement parameter which is detected with the aid of an optical sensor and which indicates information about a size of the deposited shipment, measurement information is determined and provided, wherein the measurement information represents a size of the shipment deposited in the measuring module. In this case, the correspondingly provided measurement information may indicate for example a height of the shipment in an appropriate unit (e.g. height 35 cm). In another example, the measurement information indicates that a size of the shipment is greater or less than a predetermined threshold value (e.g. that a height of the shipment is greater or less than 35 cm).

For example, at least one shipping option for shipping the shipment is determined at least partially based on the provided measurement information. This should be understood for example such that the measurement information is transmitted from the control unit of the measuring module for example to a backend server or to a control unit of a compartment installation and is obtained there as at least one measurement information. After the obtaining of the measurement information, at the backend server or at the control unit of the compartment installation, at least one shipping option for shipping the shipment is determined at least partially based on the provided measurement information. This should be understood to mean that in addition to the at least one measurement information, for example, one or more further pieces of measurement information may be obtained, wherein a shipping option for shipping the shipment is determined based on the at least one obtained measurement information and the obtained one or more further pieces of measurement information.

A shipping option for shipping the shipment should be understood for example as a shipping option (e.g. a shipping product or a shipping service) according to which shipping of the shipment is offered on the part of a shipping service provider. One or more shipping options for shipping a shipment may arise depending on the weight and/or the size. Accordingly, one or more shipping options may be determined at least partially based on the obtained measurement information.

In one example, based on measurement information according to which the weight of a shipment is 2 kg and/or a size of a shipment is at most 60 cm in height, the shipping options “package” or “parcel” may be determined if such two shipping options for shipping are offered for a shipment of this weight and/or this size. These shipping options differ for example in one or more aspects such as, for example, available shipment tracking or transport liability. Depending on or independently of such exemplary shipping options, further shipping options for shipping the shipment may be determined, for example an optional transport insurance, shipping as bulky goods, payment by cash on delivery and/or climate-neutral shipping.

Determining the shipping option at least partially based on the measurement information may comprise for example a comparison of the measurement information with a data set regarding a plurality of shipping options, which involves determining which at least one shipping option of the plurality of shipping options is appropriate in view of the weight represented by the measurement information and/or the size represented by the measurement information.

Furthermore, for example, a shipping option may be determined based on the at least one measurement information and additionally based on further information such as, for example, on one or more further pieces of measurement information.

For example, after determining the at least one shipping option, shipping information for shipping the shipment may be determined at least partially based on the at least one shipping option and a user input. By way of example, the user may select one or more of the determined shipping options and thus determine shipping information, wherein the shipping information specifies that (e.g. selected) shipping option or those (e.g. selected) shipping options according to which the shipment is to be shipped. For example, shipping information specifies whether the shipment is to be shipped for example as a parcel or package or in other examples furthermore with a transport insurance or climate-neutrally.

The described procedure with the aid of a lockable measuring module advantageously makes it possible to take account of a weight and/or a size of a shipment for determining one or more shipping options appropriate for shipping the shipment. In particular, the use of the lockable measuring module makes possible secure outdoor operation with protection against vandalism and environmental influences. This concerns for example protection of the measuring module (e.g. of the comparatively sensitive sensor system arranged in the compartment of the measuring module) against malicious damage in the unused state of the measuring module. In other examples, the measuring module may additionally be protected against a manipulation of the measuring process for determining measurement information. By way of example, the measuring module may be operated as part of a compartment installation or in direct proximity to a compartment installation in order to make it possible for a user to conveniently determine the possible shipping options for a shipment to be shipped before the user stores the shipment in the compartment installation.

Further advantages of the exemplary aspects of the present disclosure are described below on the basis of exemplary embodiments, the disclosure of which is intended to be equally applicable to all aspects of the present disclosure.

In one exemplary embodiment, the method according to the first aspect furthermore comprises:
determining, after causing the opening of the measuring module, whether the shipment has been deposited in the measuring module;
causing the locking of the measuring module if it is determined that the shipment has been deposited in the measuring module; and
causing the unlocking of the measuring module after the at least one measurement parameter of the shipment has been obtained.

For example, the control unit of the measuring module determines whether, after causing the opening of the measuring module, a shipment was deposited in the measuring module by a user. This determining comprises for example determining whether a shipment is located in the compartment of the measuring module at a point in time after causing the opening and furthermore for example before a point in time of obtaining the at least one measurement parameter. Such determining may be effected by means of the at least one sensor of the measuring module (e.g. a weight sensor) which is configured to determine at least one measurement parameter of a shipment deposited in the measuring module. By way of example, if a weight sensor of the measuring module does not register any loading, it may be determined that no shipment is located in the measuring module and that accordingly no shipment has been deposited in the measuring module.

Causing the locking and unlocking of the lockable measuring module may be understood for example such that locking and unlocking of the compartment is caused by the control unit of the measuring module. For the purpose of causing the locking and unlocking, for example, the control unit of the measuring module may control the lock control unit of the measuring module (e.g. by means of a respective electrical signal), such that the lock control unit locks or unlocks a lock of the compartment of the measuring module. In another example, the control unit of the measuring module may lock and unlock the lock of the compartment of the measuring module directly (i.e. without causing) and without the additional use of a lock control unit.

By virtue of the measuring module being locked if it is determined that the shipment has been deposited in the measuring module, and the measuring module subsequently being unlocked after the at least one measurement parameter of the shipment has been obtained (e.g. at the control unit of the measuring module), the measuring module is locked for example while the at least one measurement parameter of the shipment is detected. Advantageously, the measuring process may thus be protected, for example against environmental influences or manipulation. Otherwise, for example, a user might manipulate the measuring process in such a way that measurement information representing a falsified weight and/or a falsified size of the deposited shipment is determined.

In one exemplary embodiment according to the first aspect, the opening of the lockable measuring module is caused if it is determined that obtained access information provides authorization for opening the measuring module.

For example, the measuring module may be locked in principle (e.g. according to a presetting) as long as the measuring module is not being used for determining measurement information. In this way, the measuring module in the unused state may be protected against vandalism, for example. In this case, the opening of the measuring module may comprise unlocking of the measuring module, such that the measuring module is only unlocked and opened if determining measurement information is imminent. Imminent determining of measurement information may be indicated for example by transmitting access information (e.g. of a user who would like to store a shipment) to the control unit of the measuring module, wherein the access information provides authorization for opening the measuring module. Access information may represent for example one or more access parameters, wherein for example an access parameter specifies a period of time in which the access information provides authorization for opening the measuring module.

Determining that the obtained access information provides authorization for opening the measuring module may be carried out by the control unit of the measuring module, for example. Alternatively or additionally, the determining may be carried out by a control unit of a compartment installation, wherein the control unit of the compartment installation may subsequently forward the result of the determining to the control unit of the measuring module, such that the control unit of the measuring module causes, if appropriate, the opening and unlocking of the measuring module (e.g. by actuation of the lock control unit of the measuring module).

Access information may be manifested in diverse ways. It may involve for example letters, numbers, symbols, patterns, bit sequences or the like. A combination of the aforementioned formats is also possible. Exemplary access information might comprise or consist of 5, 8, 9, 10, 20, 50, a number between the mentioned values, or more or fewer alphanumeric characters. In particular, access information may be e.g. a code word, e.g. a code word chosen, e.g. randomly, by a user or an apparatus. Access information may additionally or instead also contain a user identifier, for example a customer number, personal details, a personal cryptographic key or similar information, e.g. uniquely assignable to a user. Access information may be, inter alia, graphically representable, readable by humans and/or machines and/or communicatable electronically and/or by radio, to mention just a few examples.

Access information may be communicated for example from a mobile device (e.g. a cellular phone of the user who would like to store a shipment) to the control unit of the measuring module. This communication may be effected for example by means of a radio connection (e.g. Bluetooth). In another example, the access information may be communicated by means of an optical pattern, wherein the optical pattern is displayed on a screen of the mobile device for capture by a capture unit of the control unit of the measuring module. The optical pattern may be for example a QR code or a barcode and the capture unit may be for example a scanner for scanning corresponding patterns. In another example, the access information is communicated by means of the access information being displayed on a screen of the mobile device for visual acquisition by a user of the mobile device, who then inputs the access information on an input unit of the measuring module, in particular a keyboard or a touch-sensitive screen. In this case, the access information may be displayed for example as an alphanumeric character string on the screen of the mobile device.

The obtained access information may be generated for example in the context of a reserving process. In such an example, a user who would like to store a shipment reserves a use of the measuring module (e.g. via an Internet site of a postal service provider that operates the measuring module). As a consequence of the reserving, the user may obtain access information which provides authorization for opening the measuring module (e.g. by the access information being obtained on a mobile device of the user).

Advantageously, by way of the access information, it may be ensured that the measuring module may only be opened (e.g. unlocked) by a user who is authorized for opening. By way of example, in other cases the measuring module may remain closed and locked and, in this way, the measuring module (e.g. the comparatively sensitive sensor system arranged in the compartment of the measuring module) may be protected in particular against vandalism.

In one exemplary embodiment, the method according to the first aspect furthermore comprises:
determining, after the at least one measurement parameter has been obtained, whether a shipment is located in the measuring module; and
if it is determined that no shipment is located in the measuring module, causing the locking of the measuring module.

Determining whether a shipment is located in the measuring module may be effected for example by means of the at least one sensor of the measuring module (e.g. a weight sensor) which is configured to determine at least one measurement parameter of a shipment deposited in the measuring module. By way of example, if a weight sensor of the measuring module does not register any loading, it may accordingly be determined that no shipment is located in the measuring module and that accordingly a shipment previously deposited in the measuring module has been removed again.

After the at least one measurement parameter has been obtained and measurement information has been provided at least partially based on the obtained at least one measurement parameter, the shipment deposited in the measuring module may be removed again for example by the user who previously deposited the shipment in the measuring module. This is made possible for example by opening of the measuring module being caused after the measurement parameter has been detected.

If, after the obtaining of the at least one measurement parameter, a user has removed again the previously deposited shipment and this removal has been determined (e.g. by means of the sensor system of the measuring module) for example by the control unit of the measuring module, locking of the measuring module may be caused (e.g. by the control unit of the measuring module correspondingly controlling the lock control unit of the measuring module).

Advantageously, it may be ensured in this way that after a shipment has been measured, the measuring module is locked again (e.g. until a further measuring process is imminent). This makes it possible to protect the measuring module (e.g. of the comparatively sensitive sensor system arranged in the compartment of the measuring module) for example against vandalism, in particular in the unused state of the measuring module.

In one exemplary embodiment according to the first aspect, the at least one shipping option is determined at least partially based on the provided measurement information at a backend server, wherein providing the measurement information further comprises:
transmitting the measurement information to the backend server; or
transmitting the measurement information to a mobile device, wherein the transmitted measurement information is forwarded from the mobile device to the backend server; or
transmitting the measurement information to a compartment installation, wherein the transmitted measurement information is forwarded from the compartment installation to the backend server.

For example, at the backend server corresponding data sets are present (which are stored e.g. in an application data memory of the backend server) which are used for determining the shipping option at least partially based on the measurement information. Accordingly, for example at the backend server a comparison of the measurement information with a data set regarding a plurality of shipping options may be effected, which involves determining at the backend server which at least one shipping option of the plurality of shipping options is appropriate in view of the weight represented by the measurement information and/or the size represented by the measurement information. Furthermore, determining the at least one shipping option may additionally be based on one or more further pieces of measurement information which are likewise provided by the measuring module or in other examples are determined at the compartment installation and provided there (e.g. for subsequent transmission to the backend server).

Before the at least one shipping option is determined at least partially based on the provided measurement information at the backend server, the measurement information is transmitted for example from the control unit of the measuring module to the backend server. This is possible by way of various transmission paths, for example, wherein these transmission paths depend for example on the technical equipment of the measuring module.

According to one example, the measurement information may be transmitted from the control unit of the measuring module directly (e.g. without a mobile device or a component of a compartment installation as an additional entity in the transmission path) to the backend server. For this purpose, the measuring module (e.g. the control unit of the measuring module) has for example a communication interface configured for remote communication (e.g. an interface to a cellular mobile radio system, a DSL interface or a local area network (LAN) interface), by means of which it may communicate with the backend server. Advantageously, the measuring module may in this way independently transmit the determined measurement information to the backend server, without being reliant here for example on a connection for data transmission to a compartment installation or a further apparatus. For example, the measuring module then need not be integrated (e.g. subsequently) in an already operational compartment installation and/or for example need not be connected to a control unit of this compartment installation. In other cases, by way of example, a compartment installation in which the measuring module is integrated may not have the required technical equipment to communicate with the measuring module or to handle the determined measurement information, with the result that a possibility of independent transmission by the measuring module to the backend server may prove to be advantageous.

According to a further example, the measurement information may firstly be transmitted from the control unit of the measuring module to a compartment installation (e.g. to a control unit of the compartment installation), wherein the transmitted measurement information is subsequently forwarded from the compartment installation (e.g. the control unit of the compartment installation) to the backend server. For this purpose, the measuring module does not require a communication interface configured for remote communication, for example, because instead it is possible to have recourse to such a communication interface of the compartment installation for forwarding the measurement information to the backend server. Advantageously, the measuring module may for example be configured more cost-effectively and be equipped merely with a more cost-effective communication interface which is sufficient for communication with a compartment installation (in which the measuring module is e.g. integrated).

According to a further example, the measurement information may firstly be transmitted from the control unit of the measuring module to a mobile device, wherein the transmitted measurement information is subsequently forwarded from the mobile device to the backend server. The mobile device may be for example a mobile device (e.g. a cellular phone) of the user who would like to store the shipment deposited in the measuring module for shipping purposes. In this case, the measuring module does not require for example a communication interface configured for remote communication, but instead requires a close-range communication interface, such as, for example, a close-range radio communication (e.g. Bluetooth or NFC). For forwarding the measurement information, it is possible subsequently to have recourse to a remote communication interface of the mobile device (e.g. an interface to a cellular mobile radio system). Advantageously, the measuring module may in this way transmit the determined measurement information to the backend server, without being reliant here for example on a connection for data transmission to a compartment installation. Moreover, the measuring module may in this way at the same time be configured more cost-effectively and be equipped merely with a more cost-effective communication interface which is sufficient for close-range communication with a mobile device.

In one exemplary embodiment according to the first aspect, shipping information for shipping the shipment is determined at least partially based on the at least one shipping option and a user input.

For example, after determining the at least one shipping option, shipping information for shipping the shipment may be determined at least partially based on the at least one shipping option and a user input. By way of example, a user may select one or more of the determined shipping options and thus determine shipping information, wherein the shipping information for example is based on the one or more selected shipping options and specifies whether the shipment is to be shipped for example as a parcel or package or in other examples furthermore with a transport insurance or climate-neutrally.

Determining shipping information and/or the user input for this purpose may be effected for example at a mobile device (e.g. a cellular phone of the user who would like to store a shipment), at a compartment installation (e.g. at a control unit of a compartment installation which the measuring module is part of) and/or at the backend server at which the at least one shipping option was determined. For this purpose, for example, the at least one shipping option is transmitted from the backend server to the mobile device or to the compartment installation.

A shipping option may be selected for example by means of a user input (e.g. at a mobile device or at a compartment installation), wherein the at least one determined shipping option is displayed to a user for example on a touch-sensitive screen (e.g. of the mobile device or of the compartment installation) and the user selects at least one of the displayed shipping options via an input unit (e.g. a keyboard or the touch-sensitive screen). After shipping information has been determined by means of this selecting of a shipping option, for example, this shipping information may be sent back from the mobile device or from the compartment installation to the backend server.

In another example, shipping information may also be determined without a user input. This may be the case, for example, if only one shipping option was determined and there is no need to select a shipping option from a plurality of shipping options in order to determine shipping information.

In one exemplary embodiment, the method according to the first aspect furthermore comprises:
causing the providing of a shipping labeling, wherein the shipping labeling is at least partially based on the shipping information.

Shipping information specifies for example that shipping option or those shipping options according to which a shipment is to be shipped. For example, shipping information specifies whether the shipment is to be shipped for example as a parcel or package or in other examples furthermore with a transport insurance or climate-neutrally. In order to label a shipment with shipping information assigned thereto and thus to prepare the shipment for shipping, the shipping information may be used for example for creating a shipping labeling. The shipping labeling accordingly indicates that shipping option or those shipping options according to which a shipment is to be shipped. Furthermore, the shipping labeling may indicate further pieces of information (e.g. address information of the recipient and/or of the sender of the shipment). The shipping labeling may for example be an optical pattern (e.g. a QR code or a barcode), comprise alphanumeric characters and/or be present in the form of a code.

For example, providing the shipping labeling comprises printing the shipping labeling on the shipment deposited in the measuring module. For this purpose, the measuring module may have printing means (e.g. a laser printer) which print the shipping labeling on the deposited shipment (e.g. on a side of the shipment facing the printing means) using ink or toner powder, for example. In another example, the measuring module has for example printing means which print out the shipping labeling in the form of a label and provide it in such a way that a user may remove the label from the measuring module and subsequently apply (e.g. stick) it on the shipment. This may be effected for example after the at least one measurement parameter of the shipment has been detected and the shipment has been removed again from the measuring module.

In order that, for example, the control unit of the measuring module may carry out the providing of the shipping labeling based at least partially on shipping information, the shipping labeling may be obtained previously at the control unit of the measuring module. This comprises for example the control unit of the measuring module receiving the shipping information (e.g. from the backend server) and determining (e.g. producing) the shipping labeling based on the received shipping information. In another example, the control unit of the measuring module may receive the shipping labeling (e.g. from the backend server at which the shipping labeling was previously determined).

Causing the providing of the shipping labeling should be understood for example such that the control unit of the measuring module, at which control unit the shipping labeling is present, for example actuates printing means of the measuring module such that said printing means provide the shipping labeling (and e.g. print it on the shipment or issue it as a label).

In one exemplary embodiment, the method according to the first aspect furthermore comprises:
causing the packaging of the shipment at least partially based on the provided measurement information.

Causing the packaging of the shipment should be understood for example such that the control unit of the measuring module actuates packaging means of the measuring module, for example, such that these packaging means package the shipment deposited in the measuring module (e.g. in particular while the shipment is located in the measuring module). For example, by way of the packaging, the shipment is completely or at least partially wrapped with a packaging material (e.g. cardboard, a bag, a film and/or an envelope) by the packaging means of the measuring module (e.g. a suitable packaging mechanism such as e.g. an automatic packaging apparatus). By virtue of the packaging of the shipment being at least partially based on the provided measurement information (and furthermore e.g. on one or more further pieces of measurement information), for example the weight of the shipment represented by the measurement information (and e.g. additionally that represented by further measurement information) and/or the represented size of the shipment may be taken into account in the context of packaging. Packaging of the shipment at least partially based on the at least one provided measurement information may be advantageous for example if the deposited shipment, before being stored, has not yet been packaged or has at least not yet been packaged in such a way that it may be shipped in the form in which it is deposited in the measuring module.

In one exemplary embodiment, the method according to the first aspect furthermore comprises:
obtaining franking information of the deposited shipment, wherein the franking information indicates franking of the deposited shipment.

For example, obtaining franking information of the deposited shipment comprises detecting a postage frank (e.g. a postage stamp, postage indicia and/or a barcode) located on the deposited shipment. This detecting may be effected for example by means of the at least one sensor of the measuring module which is configured to detect at least one measurement parameter of the shipment deposited in the measuring module. By way of example, the measuring module comprises one or more optical sensors which detect information regarding the size of a shipment deposited in the compartment of the measuring module and which additionally detect a postage frank applied on the shipment (e.g. by means of scanning or photographing the postage frank).

For example, the detected postage frank indicates a franking of the deposited shipment by virtue of the detected postage frank indicating for example whether and to what amount shipping costs for shipping the deposited shipment have been paid (e.g. already prior to the shipment being deposited in the measuring module). By way of example, the franking information is determined at least partially based on the detected postage frank, such that the franking information indicates the franking according to the postage frank. Advantageously, sensors of the measuring module that are already present for detecting at least one measurement parameter may accordingly furthermore be used to detect whether and to what amount shipping costs for shipping the deposited shipment have already been paid beforehand.

In one exemplary embodiment, the method according to the first aspect furthermore comprises:
causing, after providing the measurement information, the storing of the shipment in the compartment installation for the shipping of the shipment in accordance with the shipping information.

After providing the measurement information (e.g. by means of the control unit of the measuring module), at least one shipping option which is taken as a basis for determining shipping information at least partially based on a user input, for example, is determined at the backend server, for example. For example after a shipping labeling based on this shipping information has been provided (e.g. by printing means of the measuring module), the shipment may be stored in a compartment installation (e.g. in a compartment of the compartment installation) for the shipping of the shipment according to the shipping information. Such storing may be caused by the control unit of the measuring module in various ways.

For example, a compartment installation comprises a plurality of compartments (i.e., for example, more than one compartment or more than two compartments). The compartments are configured for example to receive shipments (e.g. letters, parcels, packages) or deliveries or objects (e.g. valuable objects, luggage, etc.). At least some of the compartments are each lockable, for example by means of a respective door or shutter. By way of example, the compartments are substantially parallelepipedal receiving containers provided with doors or shutters on one or more sides. By way of example, a plurality of compartments are arranged one above another and/or next to one another in the compartment installation. By way of example, the compartment installation may consist of one or more modules arranged next to one another, wherein one or more compartments are arranged one above another in each module. The respective doors of the compartments are then fixed laterally, for example, and can be opened forward, for example. The compartments of the compartment installation may all be of the same size. Alternatively, at least some compartments of the compartment installation may be of different sizes. The compartment installation may have compartments for letters (letter compartments) and/or compartments for parcels (parcel compartments), for example. The letter compartments are each of the same size within the compartment installation, for example, although two or more different sizes are also possible. The parcel compartments may be represented with just one identical size or with different sizes in the compartment installation. The compartment installation may be designed for example as a parcel compartment installation, a combined letter and parcel compartment installation, a parcel station, a package station or a post station.

The lock of a respective compartment is controllable, for example, in particular in electronic form. In particular, at least the process of locking and/or unlocking the lock may be controlled. The lock of a compartment may be controlled by a lock control unit, for example, wherein for example all the lock control units or those of one or more modules of the compartment installation are controlled by a superordinate control unit of the compartment installation for example.

Besides such compartments of the compartment installation which are accessible from outside (e.g. from a front of the compartment installation for a user), the compartment installation may also comprise further compartments located in an interior of the compartment installation. Such an (e.g. inner) compartment in the interior of the compartment installation may be used for example to transport a shipment deposited in the measuring module for storing purposes into the compartment installation (e.g. into such a compartment in the interior of the compartment installation).

In one exemplary embodiment according to the first aspect, causing the storing of the shipment furthermore comprises:
causing the transporting of the shipment from the measuring module into the compartment installation; or
causing the opening of the measuring module, wherein the shipment is removed from the opened measuring module and is deposited in a compartment of the compartment installation, said compartment being determined at least partially based on the provided measurement information.

For example, a shipment deposited in the measuring module is transported out of the compartment of the measuring module into the compartment installation, in particular into a compartment of the compartment installation (e.g. an inner compartment of the compartment installation), with the aid of transport means of the measuring module. This is the case, for example, if the measuring module is integrated in the compartment installation as part of the compartment installation and is incorporated in the compartment installation in such a way that there is a transport connection between the measuring module and at least one compartment of the compartment installation. The transport means of the measuring module may be provided for example by a conveyor belt within the compartment of the measuring module, on which the shipment deposited in the measuring module is located and which enables the shipment to be moved from the measuring module into a compartment of the compartment installation during movement of the conveyor belt.

Causing the transporting of the shipment may be understood for example such that the transporting is caused by the control unit of the measuring module. For the purpose of causing the transporting, for example, the control unit of the measuring module may actuate the transport means of the measuring module (e.g. by means of an electrical signal), such that the transport means move the shipment into a compartment of the compartment installation.

After the transporting, for example, the compartment installation or the measuring module, by means of respective printing means, may issue (e.g. to the user) a postal receipt that serves to prove the storing of the shipment in the compartment installation.

In another example, the storing of the shipment comprises the opening of the measuring module. After the opening, the shipment may (e.g. by a user who would like to store and ship the shipment) be removed from the opened measuring module and be deposited in a compartment of the compartment installation, said compartment being determined at least partially based on the provided measurement information. In this example, the storing is caused insofar as the opening of the measuring module enables the user to remove the shipment (and prompts the user e.g. to carry out the removing). In this case, the measuring module is for example a part of the compartment installation (and e.g. integrated in the compartment installation), or the measuring module is positioned near the compartment installation, such that a user, for the purpose of storing the shipment, may remove the shipment from the measuring module and deposit it conveniently in a compartment of the compartment installation.

A compartment of the compartment installation in which the shipment is deposited may be determined for example at least partially based on the provided measurement information (and e.g. additionally on one or more further pieces of measurement information). For example, at the backend server, after the measurement information has been communicated from the measuring module to the backend server, based on the size represented by the measurement information and/or the weight represented by the measurement information, a compartment of the compartment installation is determined (e.g. selected from a plurality of compartments) which is suitable for receiving the shipment owing to the size of the compartment. For this purpose, for example, information about the number, size and/or current occupancy of the compartments of one or more compartment installations is present at the backend server.

In one exemplary embodiment according to the first aspect, causing the storing of the shipment furthermore comprises:
if it is determined at least partially based on the provided measurement information that the shipment is a letter shipment, causing the transporting of the shipment from the measuring module into the compartment installation; and
if it is determined at least partially based on the provided measurement information that the shipment is a parcel shipment, causing the opening of the measuring module, wherein the shipment is removed from the measuring module and is deposited in a compartment of the compartment installation, said compartment being determined at least partially based on the provided measurement information.

For example, a parcel shipment (e.g. a parcel or a package) has a higher weight and/or a larger size than a letter shipment (e.g. a letter), and so such a difference in weight and/or size is represented for example by respective pieces of measurement information of the letter shipment and parcel shipment. Accordingly, for example, based on the provided measurement information, it may be determined (e.g. by the backend server to which the provided measurement information is transmitted) whether the shipment deposited in the measuring module, at least one measurement parameter of which shipment has been detected, is a letter shipment or a parcel shipment. After determining whether the deposited shipment is a parcel shipment or a letter shipment, for example, corresponding information about that may be obtained at the control unit of the measuring module (e.g. by way of the information being transmitted from the backend server to the measuring module). Based on this obtained information, for example, the control unit may cause the transporting of the letter shipment from the measuring module into the compartment installation or the opening of the measuring module. Advantageously, it may thus be taken into account that a letter shipment is primarily suitable for transporting into the compartment installation owing to the lower weight and/or smaller size compared with a parcel shipment.

In addition to the at least one measurement information, determining whether the shipment is a letter shipment or a parcel shipment may be based for example on one or more further pieces of measurement information.

In one exemplary embodiment according to the second aspect, the obtained at least one measurement information is obtained from the measuring module, from a mobile device or from a compartment installation and is provided at the measuring module before the obtaining.

For example, the at least one measurement information is obtained (e.g. received) at the backend server from the measuring module at which the measurement information is provided, wherein here, as described above with regard to the method according to the first aspect, various transmission paths are possible and these various transmission paths depend for example on the technical conditions of the measuring module. According to one example, the at least one measurement information may be transmitted from the control unit of the measuring module directly (e.g. without a mobile device or a component of a compartment installation as an additional entity in the transmission path) to the backend server. According to a further example, the at least one measurement information may firstly be provided by the control unit of the measuring module and transmitted to a compartment installation (e.g. to a control unit of the compartment installation), wherein the transmitted measurement information is subsequently forwarded from the compartment installation (e.g. the control unit of the compartment installation) to the backend server. According to a further example, the at least one measurement information may firstly be provided by the control unit of the measuring module and transmitted to a mobile device, wherein the transmitted measurement information is subsequently forwarded from the mobile device to the backend server.

In one exemplary embodiment, the method according to the second aspect furthermore comprises:
obtaining further measurement information, wherein the further measurement information represents at least one size of the shipment deposited in the measuring module, wherein the further measurement information is at least partially based on at least one further measurement parameter of the shipment, wherein the at least one further measurement parameter of the shipment is captured by a camera unit of the compartment installation, and wherein determining at least one shipping option for shipping the shipment is at least partially based on the at least one measurement information and the further measurement information.

For example, the further measurement information is obtained at a compartment installation or at a backend server, such that after the obtaining at the compartment installation or at the backend server, at least one shipping option for shipping the shipment may be determined at least partially based on the further measurement information. Obtaining further measurement information should be understood for example such that this further measurement information is obtained in addition to the at least one measurement information and accordingly at least two pieces of measurement information are obtained overall.

For example, the at least one measurement information is provided by the measuring module and is transmitted from there to the backend server, and the further measurement information is provided by the compartment installation and is transmitted from there to the backend server. For example, the at least one measurement information represents a weight of the deposited shipment and the further measurement information represents a size of the deposited shipment.

After obtaining the at least one measurement information and the further measurement information, for example, at least one shipping option may be determined at least partially based on the at least one measurement information and the further measurement information. For this purpose, for example, a shipment's size represented by the at least one measurement information (additionally or alternatively a represented weight) and a shipment's size represented by the further measurement information (additionally or alternatively a represented weight) may be taken into account, for example by averaging the two represented sizes (additionally or alternatively the represented weights). For example, based on an averaged size (additionally or alternatively on an averaged weight), at least one shipping option may then be determined, the latter being offered for shipping a shipment of this averaged size (additionally or alternatively of the averaged weight).

The further measurement information represents in particular a size (and e.g. not a weight) of the shipment deposited in the measuring module. For this purpose, the further measurement information may be determined for example at least partially based on at least one further measurement parameter of the shipment which depends on the size of the shipment. For this purpose, the at least one further measurement parameter may be captured by a camera unit of the compartment installation, for example, wherein said camera unit captures one or more images (e.g. with the image information thereof as exemplary measurement parameters) of the shipment and these images make it possible to determine a size of the shipment by means of an evaluation. For example, the camera unit of the compartment installation may have sensors or modules (e.g. an infrared camera and an infrared projector) for capturing a three-dimensional image representation of the shipment, wherein this three-dimensional image representation may be provided by captured measurement parameters and enables the size of the shipment to be determined.

The camera unit of the compartment installation is for example a part of the compartment installation and is fitted for example at the front of the compartment installation. By way of example, this camera unit is used primarily for purposes other than the above-described capture of a measurement parameter, such as, for example, monitoring of the compartment installation or identification of a user of the compartment installation. For example, the at least one further measurement parameter based on which the further measurement information is determined may be captured before the shipment is deposited in the measuring module, wherein, for example, the at least one measurement parameter based on which the at least one measurement information is determined is captured after the shipment has been deposited in the measuring module and while the shipment is located in the measuring module.

For example, the at least one measurement information represents a weight of the shipment and the further measurement information represents a size of the shipment. In this case, the measuring module may advantageously be used to determine the weight of the shipment, while a camera unit fitted to the compartment installation may be used to determine the size of the shipment. Consequently, the camera unit present at the compartment installation also for other purposes, for example, may be used for the size determination, such that the measuring module does not require a dedicated camera unit for the size determination and may be equipped just with a scale, for example, in order to determine the weight of the shipment.

In one exemplary embodiment, the method according to the second aspect furthermore comprises:
determining, at least partially based on the at least one shipping option and a user input, shipping information for shipping the shipment.

Determining shipping information at least partially based on the at least one shipping option may be effected at least partially by the backend server at which the shipping information is determined. For example, the determining may comprise transmitting the at least one shipping option to a mobile device or to a compartment installation, wherein the at least one determined shipping option is displayed to a user for example on a touch-sensitive screen (e.g. of the mobile device or of the compartment installation) and the user selects at least one of the displayed shipping options via an input unit (e.g. a keyboard or the touch-sensitive screen). After shipping information has been determined by means of this selecting of a shipping option, for example, this shipping information may be sent back from the mobile device or from the compartment installation to the backend server.

In one exemplary embodiment, the shipping information indicates at least one shipping option selected from the at least one shipping option, and furthermore indicates a shipping cost amount of the at least one selected shipping option, and the method according to the second aspect in particular furthermore comprises:
determining, at least partially based on franking information obtained from the measuring module and the shipping cost amount of the selected shipping option, whether the shipment is sufficiently franked.

As described above, by way of example, a user may select one or more of the determined shipping options and thus determine shipping information, wherein the shipping information indicates (e.g. represents) the one or more selected shipping options. By way of example, a shipping cost amount is assigned to the at least one selected shipping option, wherein this shipping cost amount of the selected shipping option becomes due for the shipping of the shipment according to the selected shipping option. For example, the shipping cost amount of the selected shipping option is determined at the backend server at which the shipping information is determined. The shipping information then also indicates the shipping cost amount of the selected shipping information in addition to the selected shipping option, for example. Advantageously, both the measurement information provided by the measuring module and the shipping option selected by the user are used as a basis for determining the shipping cost amount, such that the shipping cost amount is determined flexibly and for example not just by the measurement information alone. For example, the shipping cost amount of the selected shipping option may subsequently be invoiced to the user.

In a further example, the shipping cost amount of the selected shipping option is used for determining whether the shipment deposited in the measuring module is sufficiently franked. This determining may be effected for example by comparing the shipping cost amount of the selected shipping option with shipping costs that have possibly already been paid beforehand for the shipping of the deposited shipment. These shipping costs paid beforehand are indicated for example by franking information of the deposited shipment, wherein this franking information for example is obtained at the measuring module and is subsequently transmitted to the backend server, wherein at the backend server it is determined whether the shipment is sufficiently franked (e.g. whether the shipping costs paid beforehand cover the shipping costs of the selected shipping option). For example, possible subsequent franking may then be invoiced to the user.

In one exemplary embodiment, the method according to the second aspect furthermore comprises:
determining, at least partially based on the obtained at least one measurement information, a compartment of the compartment installation; and
causing the opening of the determined compartment of the compartment installation.

For example, determining a compartment of the compartment installation is carried out by the backend server at least partially based on the at least one measurement information obtained at the backend server. As described above with regard to the method according to the first aspect, for example, at the backend server, after the measurement information has been communicated from the measuring module to the backend server, based on the size represented by the measurement information and/or the weight represented by the measurement information, a compartment of the compartment installation is determined (e.g. selected from a plurality of compartments) which is suitable for receiving the shipment owing to the size of the compartment. For this purpose, for example, information about the number, size and/or current occupancy of the compartments of one or more compartment installations is present at the backend server. Determining a compartment of the compartment installation may comprise for example checking whether, on the basis of the size represented by the measurement information and/or the weight represented by the measurement information, a compartment of the compartment installation is available which is suitable for receiving the shipment owing to the size of the compartment. It is thus possible for example to check whether the compartment installation has a corresponding compartment in principle and/or whether such a compartment is unoccupied at the present time. Advantageously, the capacity of the compartment installation may thus be checked on the basis of the measurement information.

Furthermore, determining a compartment of the compartment installation may additionally be based on further obtained measurement information, besides the obtained at least one measurement information.

After determining a compartment of the compartment installation, opening of the determined compartment of the compartment installation may be caused by the backend server, for example, by virtue of the backend server transmitting an identifier of the determined compartment to a control unit of the compartment installation to which the determined compartment belongs. This control unit may for example subsequently cause the opening of the determined compartment (e.g. by actuating a corresponding lock control unit), wherein this opening may be regarded as part of the storing of the shipment in the compartment installation (e.g. a user deposits the shipment removed from the measuring module in the opened compartment).

In one exemplary embodiment according to the various aspects, the measuring module comprises at least one sensor for detecting the at least one measurement parameter of the shipment, wherein the at least one measurement parameter of the shipment is detected by the at least one sensor while the shipment is located in the measuring module. For example, the compartment of the measuring module is opened or closed (e.g. locked) during the detecting of the measurement parameter.

In one exemplary embodiment according to the various aspects, the measuring module is a part of the compartment installation. This may be understood for example such that the measuring module is integrated in the compartment installation (e.g. is installed in the compartment installation), such that the measuring module is conveniently accessible to a user of the compartment installation. By way of example, the measuring module as part of the compartment installation may be connected to the control unit of the compartment installation in order to transmit information such as, for example, provided measurement information to the control unit of the compartment installation. In another example, the measuring module is part of the compartment installation and installed therein, but is not connected to the control unit of the compartment installation. Alternatively or additionally, the measuring module as part of the compartment installation may be connected to a power supply of the compartment installation, for example. For example, the measuring module as part of a compartment installation may subsequently be integrated in the compartment installation (e.g. in order subsequently to supplement the compartment installation by the measuring module).

In a further exemplary embodiment according to the various aspects, the measuring module is not part of the compartment installation and for example not integrated in the compartment installation and/or for example configured without communication connection to the compartment installation. In such a case, the measuring module may be positioned (e.g. installed) in proximity or for example next to the compartment installation in order to make it possible for a user to conveniently determine the possible shipping options for a shipment to be shipped before the user stores the shipment in the compartment installation.

In one exemplary embodiment, the apparatus according to the first aspect is a control unit of the measuring module. As already described, the steps of the method according to the first aspect may be performed by a control unit of the measuring module, wherein the control unit of the measuring module should be understood as a component of the measuring module. In a further example, the measuring module may not have a dedicated control unit, such that for example the control unit of a compartment installation or a backend server perform the method according to the first aspect and should be understood as an apparatus according to the first aspect. By way of example, the control unit of the compartment installation or the backend server then performs the tasks and functions of the above-described control unit of the measuring module.

In one exemplary embodiment, the apparatus according to the second aspect is a control unit of the compartment installation or the backend server. As described above, the steps of the method according to the second aspect may be performed by a control unit of the compartment installation or the backend server.

According to a further aspect of the present disclosure, a system comprising at least the apparatus according to the first aspect and the apparatus according to the second aspect is disclosed.

By way of example, the apparatus according to the first aspect is the control unit of the measuring module and the apparatus according to the second aspect is a control unit of the compartment installation or the backend server. For example, the system may comprise further apparatuses and/or components of apparatuses, such as, for example, at least one measuring module, at least one compartment installation or at least one mobile device (e.g. a cellular phone of a user who would like to store a shipment).

The above-described exemplary embodiments and exemplary configurations of all aspects of the present disclosure should also be understood as disclosed in all combinations with one another. In particular, the disclosure of a method step is also deemed to be disclosure of means for carrying out the respective method step. Likewise, the disclosure of means for carrying out a method step is also deemed to be disclosure of the method step itself.

Further advantageous exemplary configurations of the present disclosure can be gathered from the following detailed description of some exemplary embodiments in particular in association with the figures. The accompanying figures are however only intended for the purpose of elucidation, but do not serve for determining the scope of protection of the claims. The accompanying drawings are not necessarily true to scale and are intended to only reflect the general concept of the present invention by way of example. In particular, features which are included in the figures are in no way intended to be considered a necessary part of the present invention.

### BRIEF DESCRIPTION OF THE DRAWINGS

### In the Figures:

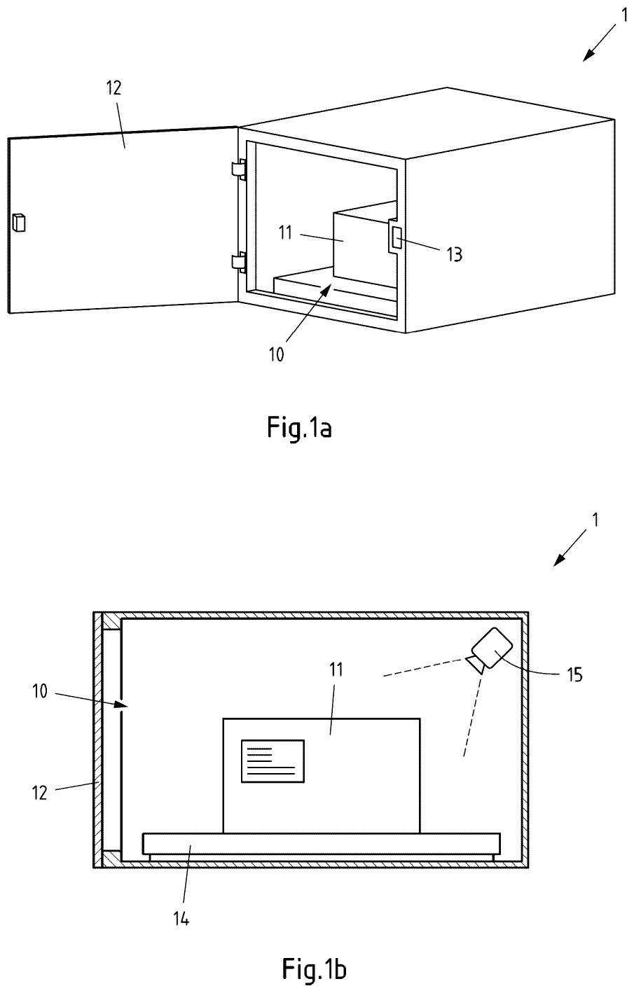

FIGS. 1a and 1b show schematic illustrations of exemplary embodiments of a measuring module according to the various aspects of the present disclosure;

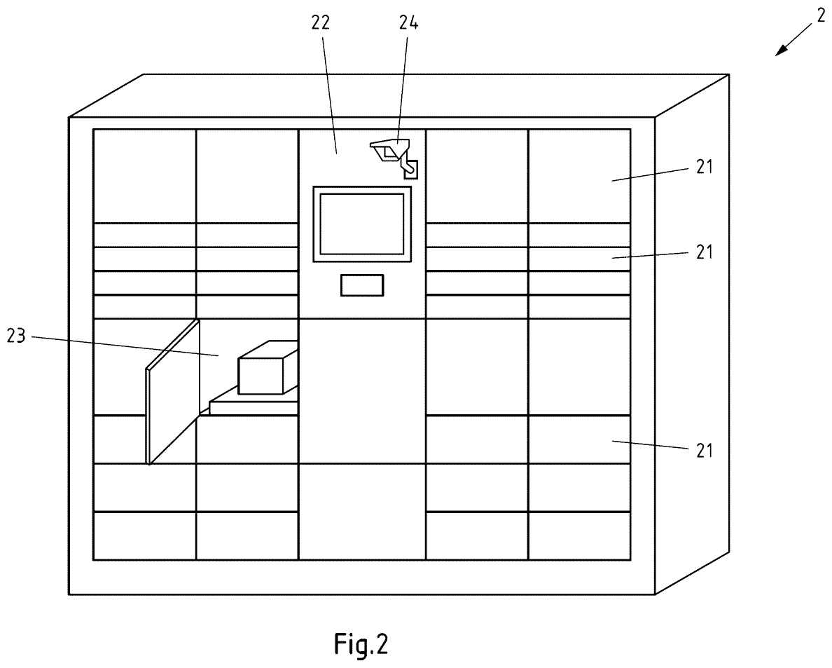

FIG. 2 shows a schematic illustration of one exemplary embodiment of a compartment installation according to the various aspects of the present disclosure;

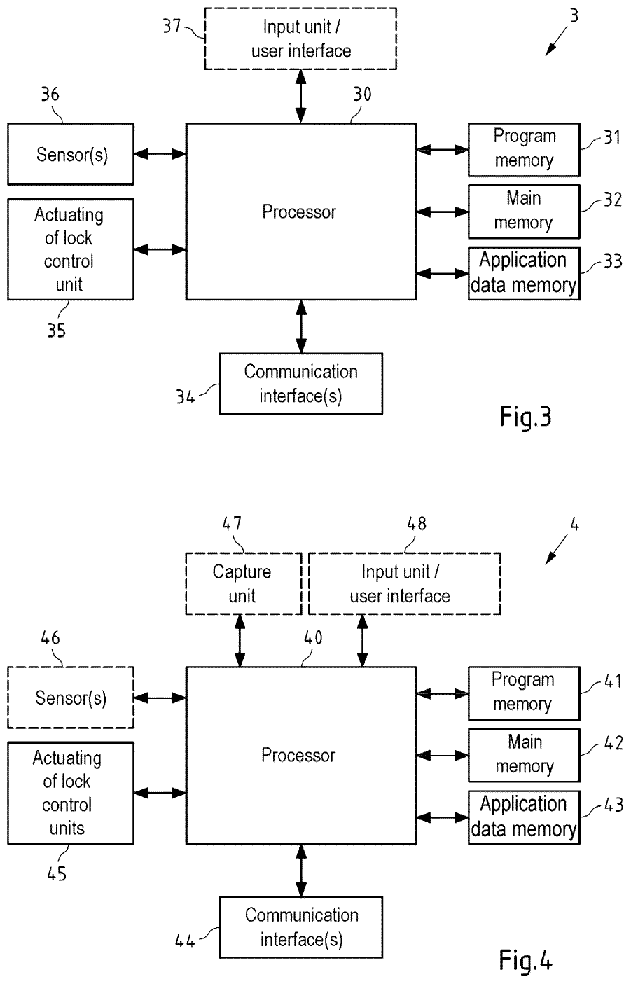

FIG. 3 shows a schematic illustration of one exemplary embodiment of a control unit of a measuring module according to the various aspects of the present disclosure;

FIG. 4 shows a schematic illustration of one exemplary embodiment of a control unit of a compartment installation according to the various aspects of the present disclosure;

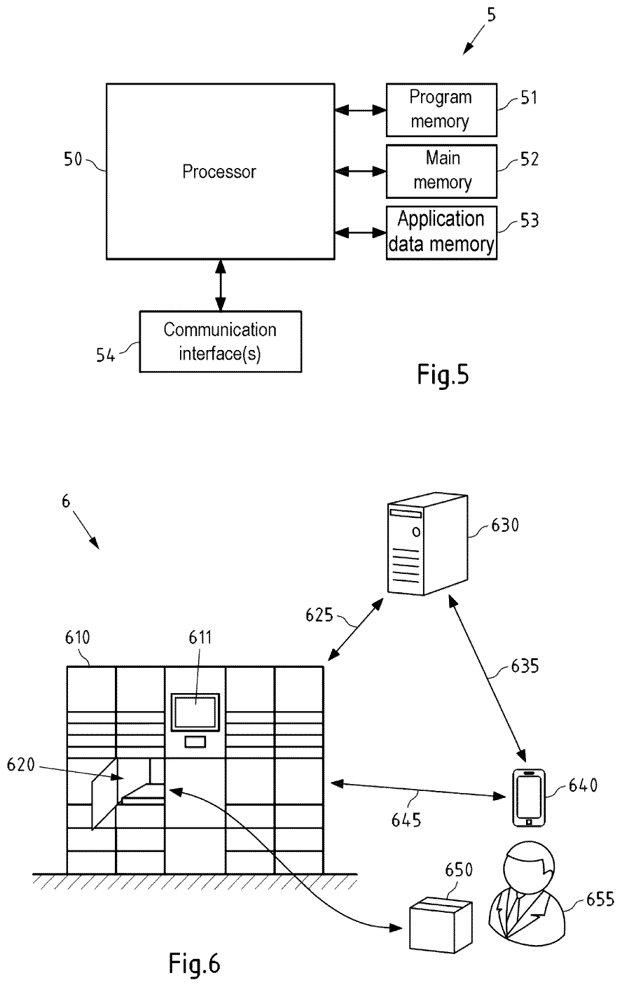

FIG. 5 shows a schematic illustration of one exemplary embodiment of a backend server according to the various aspects of the present disclosure;

FIG. 6 shows a schematic illustration of one exemplary embodiment of a system according to a further aspect of the present disclosure;

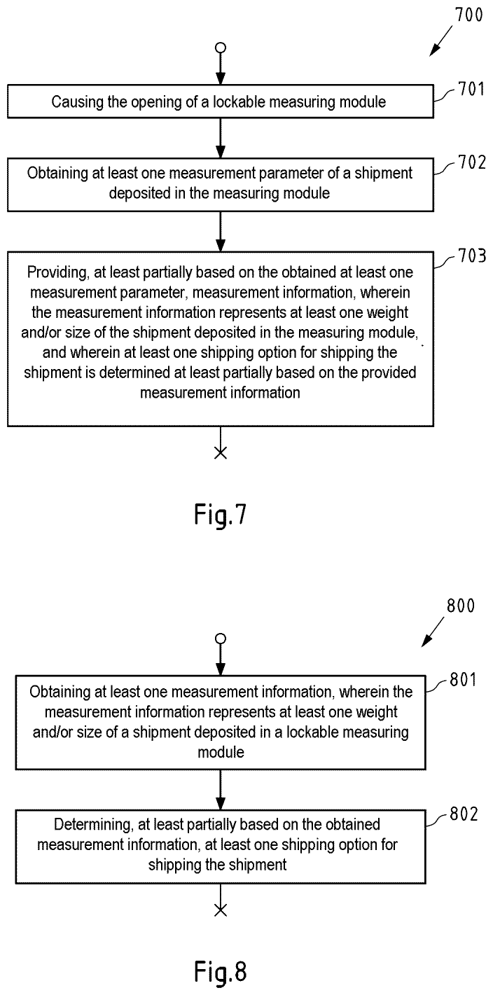

FIG. 7 shows a flowchart of one exemplary embodiment of a method according to the first aspect of the present disclosure;

FIG. 8 shows a flowchart of one exemplary embodiment of a method according to the second aspect of the present disclosure; and

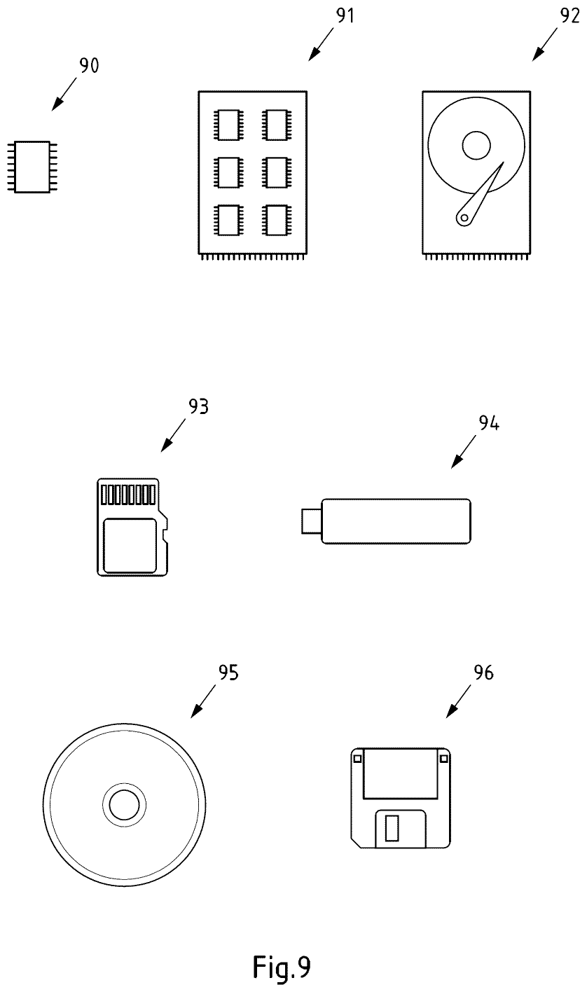

FIG. 9 shows exemplary embodiments of storage media.

### DETAILED DESCRIPTION OF THE INVENTION

FIG. 1a and FIG. 1b show schematic illustrations of exemplary embodiments of a measuring module 1 according to the various aspects of the present disclosure.

In this case, FIG. 1a shows a perspective external view of the measuring module 1 and FIG. 1b shows a cross section through the measuring module 1.

The measuring module 1 comprises for example at least one compartment 10 configured to receive at least one shipment 11 (e.g. a letter, parcel or package). Such a compartment 10 of the measuring module is lockable (e.g. closable by lock), for example by means of a door 12.

Lockability of the measuring module 1 is afforded, by way of example, by a lock 13 of the door 12 in order to be able to control users' access to the compartment 10 and thus to the use of the measuring module 1. The lock 13 of the compartment 10 may return to a locked position as standard, for example, and then be actuable only for unlocking purposes, for example. After the lock 13 has been unlocked, it is then possible for the door 12 of the compartment 10 to be opened, for example. Since the lock 13 automatically returns to the locked position, locking of the compartment 10 may be achieved by closing the door 12, for example by virtue of a catch function of the lock 13 being utilized when closing the door 12.

For example, the compartment 10 of the measuring module 1 may be either open or closed. In the open state of the compartment 10, the lock 13 of the compartment 10 is unlocked. The door 12 of the compartment 10 may then be opened by a person without force being applied, for example, or stands open (FIG. 1a shows by way of example an opened door 12). In the closed state of the compartment 10, by contrast, the lock 13 of the compartment 10 is locked (FIG. 1b shows by way of example a closed door 12). The door 12 of the compartment 10 may then no longer be opened by a person who is not authorized for opening without force being applied, for example.

The lock 13 of the compartment 10 of the measuring module 1 is controllable, for example, in particular in electronic form. In particular, at least the process of closing (e.g. locking) and/or opening (e.g. unlocking) of the lock may be controlled (e.g. caused). The lock 13 of the compartment 10 may be controlled for example by a lock control unit comprised by the measuring module 1, wherein the lock control unit of the measuring module is controlled for example by a superordinate control unit of the measuring module 1 (not visible in FIG. 1a and FIG. 1b).

Besides at least one compartment 10 and a control unit, for example, the measuring module 1 comprises at least one sensor configured to detect at least one measurement parameter of the shipment 11 deposited in the measuring module 1. In particular, the at least one measurement parameter of the deposited shipment 11 is detected while the shipment 11 is located in the measuring module 1 (as shown in FIG. 1b). A measurement parameter of a shipment 11 deposited in the measuring module 1 may be understood here as a measurement parameter which depends for example on a size (e.g. length, width, depth and/or volume) and/or on a weight of the shipment 11 and thus for example (e.g. during processing of the measurement parameter e.g. with further measurement parameters of the shipment 11) makes it possible to determine the size and/or the weight of the shipment 11. For example, a measurement parameter represents information about a weight and/or a size of the deposited shipment 11. A measurement parameter may be for example an electrical signal and/or electrically transmitted information which represents a size and/or a weight of the shipment, such that the size and/or the weight of the shipment 11 may be determined at least partially based on the measurement parameter.

In one example, the at least one sensor of the measuring module may be provided by a weight sensor, wherein, by way of example, the weight sensor may be part of an electronic scale 14 arranged in the compartment 10 of the measuring module 1. By way of example, such a scale 14 is incorporated in the base of the compartment 10, such that the weight of the shipment 11 is detected when this shipment 11 is located in the compartment 10 of the measuring module 1. In this example, the detected measurement parameter of the deposited shipment 11 in the form of an electrical signal of the electronic scale 14 indicates the weight of the deposited shipment 11.

As an alternative or in addition to a weight sensor, the measuring module 1 may comprise further sensors for detecting a measurement parameter of a shipment. For example, the measuring module comprises one or more optical or optoelectronic sensors which detect information regarding the size of a shipment 11 deposited in the compartment 10 of the measuring module 1.

In a further example, the measuring module 1 may comprise one or more cameras 15 which each capture one or more images (e.g. with the image information thereof as exemplary measurement parameters) of the deposited shipment 11, wherein for example an evaluation of the one or more images enables a size of the shipment 11 to be determined.

In further examples, the measuring module 1 may comprise further sensors (e.g. magnetic, capacitive and/or inductive sensors) configured to detect a measurement parameter of the shipment 11.

For example, the sensors of the measuring module 1 may furthermore be used to detect a postage frank (e.g. a postage stamp, postage indicia and/or a barcode) located on the deposited shipment 11. For example, the detected postage frank indicates a franking of the deposited shipment 11 by virtue of the detected postage frank indicating for example whether and to what amount shipping costs for shipping the deposited shipment 11 have been paid (e.g. already prior to the shipment 11 being deposited in the measuring module 1).

The at least one sensor of the measuring module 1 may be controlled (e.g. supervised or driven) for example by the control unit (not visible in FIG. 1a and FIG. 1b) of the measuring module. For example, the at least one sensor is connected to the control unit of the measuring module 1 in a wireless or wired manner, such that the control unit may for example cause the at least one sensor (e.g. by means of an electrical signal) to detect a measurement parameter. Furthermore, the at least one sensor may transmit for example a detected measurement parameter (e.g. by means of an electrical signal) to the control unit of the measuring module 1, wherein the control unit for example processes the obtained measurement parameter and determines measurement information based on the obtained measurement parameter.

Furthermore, the measuring module 1 may capture further components, such as, for example, printing means configured to print a shipping labeling on the shipment 11 deposited in the measuring module 1. Furthermore, the measuring module 1 may comprise transport means in order to transport the shipment 11 deposited in the measuring module 1 out of the compartment 10 into a compartment installation. This is the case, for example, if the measuring module 1 is integrated in the compartment installation as part of the compartment installation and is incorporated in the compartment installation in such a way that there is a transport connection between the measuring module and at least one compartment of the compartment installation. Furthermore, the measuring module 1 may comprise packaging means (e.g. a suitable packaging mechanism such as e.g. an automatic packaging apparatus) in order that the shipment 11 deposited in the measuring module 1 is completely or at least partially wrapped with a packaging material (e.g. cardboard, a bag, a film and/or an envelope).

Furthermore, it should be understood that the measuring module 1 (e.g. the compartment 10, the control unit and/or the at least one sensor of the measuring module 1) is designed for permanent outdoor use. Accordingly, by way of special protective measures, for example, the measuring module 1 may be configured to withstand for example environmental influences (e.g. weather-related moisture, heat, cold) or vandalism (e.g. malicious damage or manipulation of the measuring module). By way of example, the lock 13 of the compartment 10 of the measuring module 1 may be configured to be particularly secure or the door 12 of the compartment 10 of the measuring module 1 may be configured to allow the compartment 10 to be locked in a watertight manner.

FIG. 2 shows a schematic illustration of one exemplary embodiment of a compartment installation 2 according to the various aspects of the present disclosure.

For example, a compartment installation 2 comprises a plurality of compartments 21 (i.e., for example, more than one compartment or more than two compartments). The compartments 21 are configured for example to receive shipments (e.g. letters, parcels, packages) or deliveries or objects (e.g. valuable objects, luggage, etc.). At least some of the compartments 21 are each lockable, for example by means of a respective door or shutter. At least some of the compartments 21 are provided with a respective lock, for example, in order to be able to control access to these individual compartments 21 of the compartment installation 2 by users.

The lock of a respective compartment 21 is controllable, for example, in particular in electronic form. In particular, at least the process of locking and/or unlocking the lock may be controlled. The lock of a compartment 21 may be controlled by a lock control unit, for example, wherein for example all the lock control units or those of one or more modules of the compartment installation 2 are controlled by a superordinate control unit 22 of the compartment installation 2, for example.

Besides such compartments 21 of the compartment installation 2 which are accessible from outside (e.g. from a front of the compartment installation 2 for a user), the compartment installation 2 may also comprise further compartments located in an interior of the compartment installation 2 (not shown in FIG. 2). Such an (e.g. inner) compartment in the interior of the compartment installation 2 may be used for example to transport a shipment deposited in the measuring module for storing purposes into the compartment installation 2 (e.g. into such a compartment in the interior of the compartment installation 2).

As shown by way of example in FIG. 2, a measuring module 23 (e.g. the measuring module 1 shown in FIG. 1a and FIG. 1b) may be a part of the compartment installation 2. By way of example, the measuring module 23 is installed in the compartment installation 2, such that the measuring module 23 is conveniently accessible to a user of the compartment installation 2. By way of example, the measuring module 23 as part of the compartment installation 2 may be connected to the control unit 22 of the compartment installation 2 in order to transmit information such as, for example, provided measurement information to the control unit 23 of the compartment installation 2. In another example, the measuring module 23 is installed in the compartment installation 2, but is not connected to the control unit 23 of the compartment installation 2. Alternatively or additionally, the measuring module 23 as part of the compartment installation 2 may be connected to a power supply of the compartment installation 2, for example. For example, the measuring module 23 as part of a compartment installation 2 may subsequently be integrated in the compartment installation 2 (e.g. in order subsequently to supplement the compartment installation 2 by the measuring module 23).

In a departure from what is shown by way of example in FIG. 2, the measuring module 23 may also not be part of the compartment installation 2 and for example not be installed in the compartment installation 2. In such a case, the measuring module 23 may be positioned (e.g. installed) in proximity or for example next to the compartment installation 2 in order to make it possible for a user to conveniently determine the possible shipping options for a shipment to be shipped before the user stores the shipment in the compartment installation 2.

As shown by way of example in FIG. 2, the compartment installation 2 may have a camera unit 24 used primarily for example for monitoring the compartment installation 2 or identifying a user of the compartment installation 2. Furthermore, the camera unit 24 may be used to capture at least one further measurement parameter of a shipment to be stored in the compartment installation 2, such that further measurement information may be determined based on the at least one further measurement parameter, wherein the further measurement information represents in particular a size of the shipment. For example, the camera unit 24 of the compartment installation 2 may have sensors or modules (e.g. an infrared camera and an infrared projector) for capturing a three-dimensional image representation of the shipment, wherein this three-dimensional image representation may be provided by captured measurement parameters and enables the size of the shipment to be determined. By way of example, before a shipment that is to be stored is deposited in the measuring module 23, a user may hold the shipment in the image field of the camera unit 24, such that the camera unit 24 may capture one or more further measurement parameters of the shipment.

FIG. 3 shows a schematic illustration of one exemplary embodiment of a control unit 3 of a measuring module (e.g. of the measuring module 1 shown in FIGS. 1a and 1b or of the measuring module 23 shown in FIG. 2) according to the various aspects of the present disclosure.

The control unit 3 comprises, by way of example, a processor 30, a program memory 31, a main memory 32, an application data memory 33, one or more communication interface(s) 34, an actuating unit 35 for a lock or a lock control unit of the compartment of the measuring module and one or more sensors 36 (e.g. the sensors 14, 15 of the measuring module 1 shown in FIGS. 1a and 1b). A further exemplary component of the control unit 3 may be an optional input unit/user interface 37. The processor 30 executes for example a program according to the first aspect of the present disclosure, which program is stored in the program memory 31, for example as firmware. Main memory 32 serves in particular for storing temporary data during the execution of this program.

The application data memory 33 serves for storing data which are required during the processing of the program. In the present case, said data may be for example the at least one obtained measurement parameter used by the control unit 3 in order to determine measurement information. Further data such as, for example, the determined measurement information may also be stored in the application data memory 33, for example.

The communication interface(s) 34 comprises/comprise for example an interface for wireless communication (e.g. with a mobile device), for example by means of optical transmission and/or by means of communication based on electrical, magnetic or electromagnetic signals or fields, in particular on Bluetooth, NFC and/or RFID (Radio Frequency Identification). The control unit 3 is for example furthermore configured for direct communication with a backend server, i.e. has for example a communication interface that enables access to the Internet or to some other network to which the backend server is connected.

The actuating unit 34 makes it possible to open or to unlock a compartment of the measuring module (e.g. the compartment 10 shown in FIG. 1a and FIG. 1b) in a targeted manner in order to cause an opening, in particular by actuating the lock of the compartment or a lock control unit of the compartment. Additionally or alternatively, the locking of the compartment may be caused. The actuating unit 35 is connected to the lock or the lock control unit of the compartment via a respective wiring, for example.

The at least one sensor 36 of the control unit 3 of a measuring module is configured to detect at least one measurement parameter of a shipment deposited in the measuring module. In particular, the at least one measurement parameter is detected by sensor 36 while the shipment is located in the measuring module (as shown e.g. in FIG. 1b). The at least one sensor 36 may be for example a weight sensor, an optical or optoelectronic sensor or a camera.

FIG. 4 shows a schematic illustration of one exemplary embodiment of a control unit 4 of a compartment installation (e.g. of the compartment installation 2 shown in FIG. 2) according to the various aspects of the present disclosure.

The control unit 4 comprises a processor 40, a program memory 41, a main memory 42, an application data memory 43, one or more communication interface(s) 44, an actuating unit 45 for the locks or lock control units of the compartments of the compartment installation, one or more optional sensors 46, an optional capture unit 47 and an optional input unit/user interface 48. The processor 40 executes for example a program according to the second aspect of the present disclosure, which program is stored in the program memory 41, for example as firmware. Main memory 42 serves in particular for storing temporary data during the execution of this program.

The application data memory 43 serves for storing data which are required during the processing of the program. In the present case, said data may be for example information which may be used by the control unit 4 in order to be able to ascertain whether access information provides authorization for access. Further data such as, for example, measurement information, a shipping option or shipping information may also be stored for example in the application data memory 43, e.g. in data structures which also represent an assignment of pieces of access information to respective indicators and/or respective compartments.

The communication interface(s) 44 comprises/comprise for example an interface for wireless communication, for example by means of optical transmission and/or by means of communication based on electrical, magnetic or electromagnetic signals or fields, in particular on Bluetooth, NFC and/or RFID (Radio Frequency Identification). The control unit 4 is for example furthermore configured for direct communication with a backend server (e.g. the backend server 5 shown in FIG. 5), i.e. has for example a communication interface that enables access to the Internet or to some other network to which the backend server is connected.

The actuating unit 45 of the control unit 4 of a compartment installation makes it possible to open or to unlock an individual compartment of the compartment installation in a targeted manner in order to enable the opening, in particular by actuating the lock of the compartment or a lock control unit of the compartment. Additionally or alternatively, the locking of a compartment may be caused. Via a respective wiring, for example, the actuating unit 45 is connected to all locks or lock control units of the compartment installation or is connected to a bus to which all locks or lock control units of the compartment installation are also linked.

The sensors 46 are optional and compartment-specific, for example. A sensor makes it possible for example to detect whether a respective shipment is located in a respective compartment and/or whether a shipment is/has been stored in the compartment and/or removed. The same sensor or a further sensor makes it possible e.g. to detect information of a shipment, for example by optically scanning a label or reading an NFC tag associated with the shipment.

The capture unit 47 is optional and, in one exemplary embodiment, a scanner which may optically capture information, e.g. a barcode or a QR code from a screen of a mobile device. In a further exemplary embodiment, the capture unit 47 is configured to read NFC tags which for example are secured to a respective shipment and/or deposited therein. The capture unit 47 may additionally or alternatively be able to capture and to process acoustic signals, i.e. e.g. by means of voice recognition.

The input unit/user interface 48 is optional and configured for communication with a deliverer/delivery entity and/or a user. This may comprise for example an output unit for displaying (e.g. via a screen or via compartment-specific luminous displays (e.g. for representing a respective state occupied/unoccupied)) or acoustically outputting pieces of information and/or a unit for obtaining pieces of information and/or data (e.g. a keyboard or a touch-sensitive screen with screen keyboard or a voice recognition module) from the persons.

FIG. 5 shows a schematic illustration of one exemplary embodiment of a backend server 5 according to the various aspects of the present disclosure. The backend server 5 may be a compartment installation management server, for example.

The backend server 5 comprises a processor 50, a program memory 51, a main memory 52, an optional application data memory 53, and one or more communication interface(s) 54. The processor executes for example a program according to the second aspect of the present disclosure, which program is stored in the program memory 51, for example as firmware. Main memory 52 serves in particular for storing temporary data during the execution of this program.

The application data memory 53 serves for storing data which are required during the processing of the program. In the present case, said data may be for example measurement information transmitted by a measuring module or shipping information based thereon. However, they may also be e.g. user identifiers and user contact data, such as email addresses and mobile radio numbers, compartment installation identifiers and shipment data. All data may be stored in an encrypted manner, for example. Moreover, pieces of information about a plurality of compartment installations may be stored in the application data memory 53, for example respective first information per compartment installation of the plurality of compartment installations and/or pieces of location information indicating a location of a respective compartment installation, for example. However, the pieces of information obtained and to be communicated may for example also only be temporarily stored in the main memory 52 and be erased again immediately after having been communicated.

The communication interface(s) 54 may be configured as at least one interface for communication with a control unit of a measuring module (e.g. the control unit 3 shown in FIG. 3), with a control unit of a compartment installation (e.g. the control unit 4 shown in FIG. 4) or a mobile device (e.g. a cellular phone of a user who would like to store a shipment). This communication may be based on the Internet Protocol (IP), for example. By way of example, for this purpose, at least one of the communication interface(s) 54 is embodied as a local area network (LAN) interface.

In the exemplary embodiments in FIGS. 3 to 5, the processor 30, 40 or 50 may be for example in each case a control unit, a microprocessor, a microcontrol unit such as a microcontroller, a digital signal processor (DSP), an application-specific integrated circuit (ASIC) or a field programmable gate array (FPGA). In the exemplary embodiments in FIGS. 3 to 5, the program memory and/or the application data memory may be for example a persistent memory, such as a read only memory (ROM), for example. The program memory may for example be fixedly connected to the respective processor 30, 40 or 50, but may alternatively also be releasably connected to the respective processor 30, 40 or 50, for example as a memory card, a floppy disk or an optical data carrier medium (e.g. a CD or DVD). The main memory of the exemplary embodiments in FIGS. 3 to 5 is used for example for storing temporary results during the processing of the program instructions, and is for example a volatile memory, such as a random access memory (RAM), for example.

FIG. 6 shows a schematic illustration of one example embodiment of a system 6 according to a further aspect of the present disclosure, by way of example comprising a compartment installation 610 (e.g. the compartment installation 2 shown in FIG. 2) with a control unit 611 of the compartment installation 610, a measuring module 620 (e.g. the measuring module 1 shown in FIG. 1a and FIG. 1b) with a control unit of the measuring module 620, a backend server 630 (e.g. the backend server 5 shown in FIG. 5) and a mobile device 640, which should be understood by way of example as a cellular phone of a user 655 who would like to store a shipment 650 in the compartment installation 610.

The control unit 611 of the compartment installation 610 is equipped by way of example with one or more communication interface(s) comprising an interface for wireless communication with the mobile device 640 via a communication connection 645. The wireless communication connection 645 is based for example on optical transmission and/or by means of communication based on electrical, magnetic or electromagnetic signals or fields, in particular close-range communication e.g. based on Bluetooth or WLAN.

The control unit 611 of the compartment installation 610 is by way of example also configured for communication with the backend server 630, i.e. has for example a communication interface that enables access to the Internet or to some other network to which the backend server 630 is connected. The control unit 611 is thus configured in particular for remote communication, i.e. has for example an interface to a cellular mobile radio system, a DSL interface or a local area network (LAN) interface, by means of which it may communicate with the backend server 630 via the communication connection 625.

The measuring module 620 is illustrated by way of example as installed in the compartment installation 610. The control unit of the measuring module 620 for example as a component of the compartment installation 610 within the compartment installation 610 may be connected to and communicate with the control unit 611 of the compartment installation 610, for example in order to transmit determined measurement information from the control unit of the measuring module 620 to the control unit 611 of the compartment installation. For this purpose, the control unit of the measuring module 620 has for example a communication interface configured for communication within the compartment installation 610 (e.g. among the various components of the compartment installation 610).

Additionally or alternatively, the control unit of the measuring module 620 is by way of example also configured for communication with the backend server 630, i.e. has for example a communication interface that enables access to the Internet or to some other network to which the backend server 630 is connected. The control unit of the measuring module 620 is thus configured in particular for remote communication, i.e. has for example an interface to a cellular mobile radio system, a DSL interface or a local area network (LAN) interface, by means of which it may communicate with the backend server 630 via the communication connection 625. The communication connection 625 may be understood for example as a communication connection between the control unit 611 of the compartment installation 610 and the backend server 630 or as a communication connection between the control unit of the measuring module 620 and the backend server 630.

Additionally or alternatively, the control unit of the measuring module 620 is equipped by way of example with one or more communication interface(s) comprising an interface for wireless communication with the mobile device 640 via a communication connection 645. The wireless communication connection 645 is based for example on optical transmission and/or by means of communication based on electrical, magnetic or electromagnetic signals or fields, in particular close-range communication e.g. based on Bluetooth or WLAN. The communication connection 645 may be understood for example as a communication connection between the control unit 611 of the compartment installation 610 and the mobile device 640 or as a communication connection between the control unit of the measuring module 620 and the mobile device 640.

The backend server 630 may manage and/or communicate with for example a plurality of compartment installations including the compartment installation 610 and/or a plurality of users including the user 655. The backend server 630 may communicate with the control unit 611 of the compartment installation 610 via a communication connection 625, for example. Additionally or alternatively, the backend server 630 may communicate with the control unit of the measuring module 620 via the communication connection 625. Furthermore, the backend server 630 may communicate with the mobile device 640 via a communication connection 635. The communication connections 625 and 645 may be e.g. respective Internet connections which by way of example also comprise in sections a transmission in a mobile radio network.

The user 655 illustrated by way of example would like to store a shipment 650 for shipping in the compartment installation 610. For this purpose, the shipment 650 is intended to be measured in the measuring module 620 before being stored. This comprises in particular providing measurement information representing at least one weight and/or size of the shipment 650 deposited in the measuring module 620 by the user 655, and wherein at least one shipping option for shipping the shipment 650 is determined at least partially based on the provided measurement information.

FIG. 7 shows a flowchart of one exemplary embodiment of a method 700 according to the first aspect of the present disclosure. Method steps 701 to 703 are described below by way of example in relation to the system 6 shown in FIG. 6. It is assumed here by way of example that method steps 701 to 703 are carried out by a control unit of the measuring module 620.

Step 701 comprises causing the opening of a lockable measuring module.

For example, the control unit of the measuring module 620 actuates the lock control unit of the measuring module 620, such that the lock control unit opens the door of the compartment of the measuring module 620 and for this purpose unlocks a lock of the door, for example. After the opening (e.g. after the unlocking) of the measuring module 620 in step 701, for example, the user 655 may deposit the shipment 650 in the opened compartment of the measuring module 620. This may involve for example a shipment which is intended to be shipped in the further course of events and for this purpose is intended to be stored in the compartment installation 610. After depositing the shipment 650 in the measuring module 620, the user 655 closes the measuring module 620, for example.

For example, the measuring module 620 opens in step 701 if the measuring module 620 obtains access information and the measuring module 620 determines that this access information provides authorization for opening the measuring module 620. Such access information may be communicated for example from the mobile device 640 of the user 655 to the control unit of the measuring module 620. The obtained access information may be generated for example in the context of a reserving process.

Step 702 comprises obtaining at least one measurement parameter of a shipment deposited in the measuring module.

After the opening of the measuring module 620 in step 701 and after the depositing of a shipment 650 in the opened measuring module 620, obtaining at least one measurement parameter of the shipment 650 deposited in the measuring module 620 ensues. Obtaining the at least one measurement parameter comprises for example detecting the at least one measurement parameter of the shipment 620 by means of the at least one sensor of the measuring module 620 while the shipment 620 is located in the compartment of the measuring module 620. After the detecting, the at least one detected measurement parameter is transmitted to the control unit of the measuring module 620, for example.

In one example, the at least one sensor of the measuring module 620 may be provided by a weight sensor, wherein the weight sensor may be part of an electronic scale arranged in the compartment of the measuring module 620 (e.g. of the scale 14 in the compartment 10 of the measuring module 1 shown in FIG. 1b). By way of example, such a scale is incorporated in the base of the compartment of the measuring module 620, such that the weight of the shipment 650 is detected. In this example, the detected measurement parameter of the deposited shipment 650 in the form of an electrical signal of the electronic scale indicates the weight of the deposited shipment 650.

As an alternative or in addition to a weight sensor, the measuring module 620 may comprise further sensors for detecting a measurement parameter of the shipment 650. For example, the measuring module 620 comprises one or more optical or optoelectronic sensors which detect information regarding the size of the shipment 650 deposited in the compartment of the measuring module 620. In this case, by way of example, by means of a light transmitter (e.g. a light-emitting diode or a laser diode) and a light receiver (e.g. a light-sensitive resistor or a photodiode), a light barrier may be realized within the compartment of the measuring module 620, such that for example an interruption of a light beam of the light barrier indicates a size of the shipment 650 deposited in the compartment. If light transmitter and light receiver are arranged at a specific height in the compartment of the measuring module 620, for example, an interruption of the light beam indicates for example that a height of the deposited shipment 650 is at least equal to the height at which light transmitter and light receiver are arranged. The measurement parameter of the deposited shipment 650 may for example be a photocurrent of the light receiver and indicate a lower limit of the height of the deposited shipment.

In a further example, the measuring module 620 may comprise one or more cameras (e.g. the camera 15 in the compartment 10 of the measuring module 1 shown in FIG. 1b) which each capture one or more images (e.g. with the image information thereof as exemplary measurement parameters) of the shipment 650 deposited in the compartment of the measuring module 620, wherein for example an evaluation of the one or more images enables a size of the shipment 650 deposited in the compartment to be determined. Furthermore, for example, one or more cameras of the measuring module 620 may for example in addition detect a postage frank (e.g. a postage stamp, postage indicia and/or a barcode) located on the deposited shipment 650, wherein franking information of the deposited shipment 650 may be determined based on the detected postage frank (e.g. by the control unit of the measuring module 620).

By way of example, a measuring process proceeding in the context of step 702 may be protected by the measuring module 620 being locked during the measuring process. For this purpose, for example, the control unit of the measuring module 620, after step 701, may determine whether the shipment 650 has been deposited in the measuring module and, if appropriate, may cause the measuring module 620 to be locked until the measuring module 620 is unlocked again after the obtaining of the measurement parameter in step 702.

Furthermore, the measuring module 620 may be locked after the obtaining of a measurement parameter in step 702 if the control unit of the measuring module 620 determines that the shipment 650 is no longer located in the measuring module 620. If, for example, after the obtaining of the at least one measurement parameter in step 702, the user 655 has removed again the previously deposited shipment 650 and this removal has been determined (e.g. detected) (e.g. by means of the sensor system of the measuring module 620) for example by the control unit of the measuring module 620, locking of the measuring module 620 may be caused. This makes it possible to protect the measuring module 620 (e.g. of the comparatively sensitive sensor system arranged in the compartment of the measuring module) for example against vandalism, in particular in the unused state of the measuring module 620.

Step 703 comprises providing, at least partially based on the obtained at least one measurement parameter, measurement information, wherein the measurement information represents at least one weight and/or size of the shipment deposited in the measuring module, and wherein at least one shipping option for shipping the shipment is determined at least partially based on the provided measurement information.

Providing, by the control unit of the measuring module 620, measurement information at least partially based on the obtained at least one measurement parameter should be understood to mean, for example, that measurement information is determined at least partially based on the obtained measurement parameter of the deposited shipment 650 (e.g. by the control unit of the measuring module 620) and subsequently for example is provided for the transmission. Such a transmission may comprise for example transmitting the measurement information to the control unit 611 of the compartment installation 610 (which forwards the measurement information to the backend server 630), to the mobile device 640 (which forwards the measurement information to the backend server 630) or to the backend server 630. Accordingly, step 703 may comprise determining the measurement information at least partially based on the obtained at least one measurement parameter and subsequently transmitting the measurement information to the backend server 630.

By way of example, in step 703, based on a measurement parameter which is detected with the aid of a weight sensor and which indicates information about a weight of the deposited shipment 650, measurement information is determined and provided, wherein the measurement information indicates the weight of the shipment 650 as 2 kg. In another example, in step 703, based on a measurement parameter which is detected with the aid of an optical sensor and which indicates information about a size of the deposited shipment 650, measurement information is determined and provided, wherein the measurement information indicates the height of the deposited shipment 650 as 35 cm.

After step 703, for example, at least one shipping option for shipping the shipment 650 is determined at least partially based on the measurement information provided in step 703. This should be understood for example such that the measurement information is transmitted from the control unit of the measuring module 620 for example to the backend server 630 or to the control unit 611 of a compartment installation 610 and is obtained there. After the obtaining of the measurement information, at the backend server 630 or at the control unit of the compartment installation 611, at least one shipping option for shipping the shipment 650 is determined at least partially based on the provided measurement information (see step 802 described below in the flowchart 800 shown in FIG. 8).

FIG. 8 shows a flowchart of one exemplary embodiment of a method 800 according to the first aspect of the present disclosure. Method steps 801 and 802 are described below by way of example in relation to the system 6 shown in FIG. 6. It is assumed here by way of example that method steps 801 and 802 are carried out by the backend server 630.

Step 801 comprises obtaining at least one measurement information, wherein the measurement information represents at least one weight and/or size of a shipment deposited in a lockable measuring module.

For example, in step 801, the backend server 630 obtains at least that measurement information which is transmitted from the control unit of the measuring module 620 to the backend server 630 in step 703 described above. This transmitting and obtaining of the measurement information in step 801 is possible by way of various transmission paths, wherein these transmission paths may depend on the technical equipment of the measuring module 620.

According to one example, the measurement information may be transmitted from the control unit of the measuring module 620 directly (e.g. without the mobile device 640 or the control unit 611 of the compartment installation 610 as an additional entity in the transmission path) to the backend server 630. Advantageously, the measuring module 620 may in this way independently transmit the determined measurement information to the backend server 630, without being reliant here for example on a connection for data transmission to the compartment installation 610 or a further apparatus. According to a further example, the measurement information may firstly be transmitted from the control unit of the measuring module 620 to the control unit 611 of the compartment installation 610, wherein the transmitted measurement information is subsequently forwarded from the control unit 611 of the compartment installation 610 to the backend server 630. Advantageously, the measuring module 620 may for example be configured more cost-effectively and be equipped merely with a more cost-effective communication interface which is sufficient for communication with the compartment installation 610. According to a further example, the measurement information may firstly be transmitted from the control unit of the measuring module 620 to the mobile device 640, wherein the transmitted measurement information is subsequently forwarded from the mobile device 640 to the backend server 630. Advantageously, the measuring module 620 may in this way transmit the determined measurement information to the backend server 630, without being reliant here for example on a connection for data transmission to the compartment installation 610. Moreover, the measuring module 620 may in this way at the same time be configured more cost-effectively and be equipped merely with a more cost-effective communication interface which is sufficient for close-range communication with the mobile device 640.

In addition to the at least one measurement information obtained in step 801, for example, further measurement information may be obtained at the backend server 630, which, for example, unlike the at least one measurement information obtained in step 801, is not provided by the control unit of the measuring module 620 and transmitted to the backend server 630, but rather is determined and provided at the control unit 611 of the compartment installation 610 and subsequently transmitted to the backend server 630. At the backend server 630, at least one shipping option may then be determined based on both pieces of obtained measurement information, as described below in step 802. For example, the at least one measurement information obtained in step 801 represents a weight of the shipment 650 and the further obtained measurement information represents a size of the shipment 650. In this case, the further measurement information may be determined for example at least partially based on at least one measurement parameter of the shipment 650 which depends on the size of the shipment 650 and is captured by a camera unit of the compartment installation 610 (e.g. the camera unit 24 of the compartment installation 2 shown in FIG. 2). By way of example, before the shipment 650 that is to be stored is deposited in the measuring module 620, the user 655 may hold the shipment 650 in the image field of the camera unit, such that the camera unit captures one or more further measurement parameters of the shipment 650 and, based thereon, further measurement information representing a size of the shipment 650 may be determined by the control unit of the compartment installation 610, for example. Afterward, the user 655 deposits the shipment 650 in the measuring module 620, for example, such that a measurement parameter of the shipment 650 may be obtained as described above for step 702. In this case, the measuring module 620 may advantageously be used to determine the weight of the shipment 650, while a camera unit fitted to the compartment installation 610 may be used to determine the size of the shipment 650. Consequently, the camera unit present at the compartment installation 610 also for other purposes, for example, may be used for the size determination, such that the measuring module 620 does not require a dedicated camera unit for the size determination and may be equipped just with a scale, for example, in order to determine the weight of the shipment 650.

Step 802 comprises determining, at least partially based on the obtained measurement information, at least one shipping option for shipping the shipment.

In one example, based on the measurement information obtained in step 801, according to which the weight of a shipment 650 is 2 kg and/or a height of the shipment 650 is 35 cm, the shipping options “package” or “parcel” may be determined at the backend server 630 if such two shipping options for shipping are offered for the shipment 650 of this weight and/or this size. These shipping options differ for example in one or more aspects such as available shipment tracking or transport liability. Depending on or independently of such exemplary shipping options, further shipping options for shipping the shipment may be determined, for example an optional transport insurance, shipping as bulky goods, payment by cash on delivery or climate-neutral shipping.

As mentioned in step 801, in step 802 the at least one shipping option may be determined based on the measurement information obtained in step 801 and additionally on one or more further pieces of measurement information.

For example, after determining the at least one shipping option in step 802, shipping information for shipping the shipment 650 may be determined at least partially based on the at least one shipping option and a user input of the user 655 at the mobile device 640 or at the compartment installation 610. By way of example, the user 655 may select one of two determined shipping options (e.g. “package” or “parcel”) and thus determine shipping information, wherein the shipping information specifies that the shipment 650 is to be shipped as “package” or as “parcel”. For this purpose, the at least one shipping option is transmitted for example from the backend server 630 to the mobile device 640 or to the compartment installation 610 and the determined shipping information is transmitted back from the mobile device 640 or respectively from the compartment installation 610 to the backend server. In this case, the shipping information indicates for example the selected shipping information and furthermore a shipping cost amount of the selected shipping option, wherein this shipping cost amount of the selected shipping option becomes due for the shipping of the shipment according to the selected shipping option. In a further example, based on the shipping cost amount of the selected shipping option and franking information obtained at the measuring module 620 for example in step 702 (which information is subsequently transmitted to the backend server 630), it may be determined whether the shipment 650 is sufficiently franked.

Afterward, for example, the backend server 630 may transmit the shipping information to the measuring module 620, at which a shipping labeling (e.g. in the form of print on the shipment 620 or a printed-out label applied to the shipment 650 by the user 655) is issued at least partially based on the shipping information. The measuring module 620 may thereupon cause the storing of the shipment 650, for example by the measuring module 620 transporting the shipment 650 into the compartment installation 610 or by the measuring module 620 opening, such that the user 655 may remove the shipment 650 and deposit it in a compartment of the compartment installation 610.

The procedure described in the flowcharts in FIGS. 7 and 8 advantageously makes it possible to take account of a weight and/or a size of the shipment 650 for determining one or more shipping options appropriate for shipping the shipment 650. In particular, the use of a lockable measuring module 620 makes possible secure outdoor operation with protection against vandalism and environmental influences. This concerns for example protection of the measuring module 620 (e.g. of the comparatively sensitive sensor system arranged in the compartment of the measuring module 620) against malicious damage in the unused state of the measuring module. The measuring module 620 will additionally be protected against a manipulation of the measuring process for determining measurement information. By virtue of the measuring module 620 being operated as part of the compartment installation 610 or in direct proximity to a compartment installation 610, this makes it possible for the user 655 to conveniently determine the possible shipping options for the shipment 650 to be shipped before the user 655 stores the shipment 650 in the compartment installation 610.

FIG. 9 shows exemplary embodiments of storage media on which for example a computer program according to the various aspects of the present disclosure may be stored. The storage medium may be for example a magnetic, electrical, optical and/or other storage medium. The storage medium may be for example part of a processor (e.g. the processor 30 in FIG. 3), for example a (nonvolatile or volatile) program memory of the processor or a part thereof (e.g. memory 31 in FIG. 3). Exemplary embodiments of a storage medium are a flash memory 90, an SSD hard disk 91, a magnetic hard disk 92, a memory card 93, a memory stick 95 (e.g. a USB stick), a CD-ROM or DVD 95 or a floppy disk 96.

The exemplary embodiments of the present invention that are described in this specification should also be understood as disclosed in all combinations with one another. In particular, the description of a feature that an embodiment comprises should also not-unless explicitly stated to the contrary—be understood in the present case to mean that the feature is indispensable or essential for the function of the exemplary embodiment. The sequence of the method steps outlined in this specification in the individual flowcharts is not mandatory; alternative sequences of the method steps are conceivable-unless indicated otherwise. The method steps may be implemented in various ways, and so implementation using software (by means of program instructions), hardware or a combination of the two is conceivable for implementing the method steps.

Terms used in the patent claims such as “comprise”, “have”, “include”, “contain” and the like do not exclude further elements or steps. The wording “at least partially” encompasses both the “partially” case and the “completely” case. The wording “and/or” should be understood to the effect that both the alternative and the combination are intended to be disclosed, that is to say that “A and/or B” means “(A) or (B) or (A and B)”. In the context of this specification, a plurality of units, persons or the like means two or more units, persons or the like. The use of the indefinite article does not exclude a plurality. A single device may perform the functions of a plurality of units or devices mentioned in the patent claims. Reference signs indicated in the patent claims should not be regarded as limitations for the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method comprising:
causing the opening of a lockable measuring module;
obtaining at least one measurement parameter of a shipment deposited in the measuring module; and
providing, at least partially based on the obtained at least one measurement parameter, measurement information, wherein the measurement information represents at least one weight and/or size of the shipment deposited in the measuring module, and wherein at least one shipping option for shipping the shipment is determined at least partially based on the provided measurement information.

2. The method according to claim 1, wherein the method further comprises:
determining, after causing the opening of the measuring module, whether the shipment has been deposited in the measuring module;
causing the locking of the measuring module if it is determined that the shipment has been deposited in the measuring module; and
causing the unlocking of the measuring module after the at least one measurement parameter of the shipment has been obtained.

3. The method according to claim 1, wherein the opening of the lockable measuring module is caused if it is determined that obtained access information provides authorization for opening the measuring module.

4. The method according to claim 1, wherein the method further comprises:
determining, after the at least one measurement parameter has been obtained, whether a shipment is located in the measuring module; and
if it is determined that no shipment is located in the measuring module, causing the locking of the measuring module.

5. The method according to claim 1, wherein the at least one shipping option is determined at least partially based on the provided measurement information at a backend server, and wherein providing the measurement information further comprises:
transmitting the measurement information to the backend server; or
transmitting the measurement information to a mobile device, wherein the transmitted measurement information is forwarded from the mobile device to the backend server; or
transmitting the measurement information to a compartment installation, wherein the transmitted measurement information is forwarded from the compartment installation to the backend server.

6. The method according to claim 1, wherein shipping information for shipping the shipment is determined at least partially based on the at least one shipping option and a user input.

7. The method according to claim 6, wherein the method further comprises:
causing the providing of a shipping labeling, wherein the shipping labeling is at least partially based on the shipping information.

8. The method according to claim 1, wherein the method further comprises:
causing the packaging of the shipment at least partially based on the provided measurement information.

9. The method according to claim 1, wherein the method further comprises:
obtaining franking information of the deposited shipment, wherein the franking information indicates franking of the deposited shipment.

10. The method according to claim 1, wherein the method further comprises:
causing, after providing the measurement information, the storing of the shipment in the compartment installation for the shipping of the shipment in accordance with the shipping information.

11. The method according to claim 10, wherein causing the storing of the shipment further comprises:
causing the transporting of the shipment from the measuring module into the compartment installation; or
causing the opening of the measuring module, wherein the shipment is removed from the opened measuring module and is deposited in a compartment of the compartment installation, said compartment being determined at least partially based on the provided measurement information.

12. The method according to claim 10, wherein causing the storing of the shipment further comprises:
if it is determined at least partially based on the provided measurement information that the shipment is a letter shipment, causing the transporting of the shipment from the measuring module into the compartment installation; and
if it is determined at least partially based on the provided measurement information that the shipment is a parcel shipment, causing the opening of the measuring module, wherein the shipment is removed from the measuring module and is deposited in a compartment of the compartment installation, said compartment being determined at least partially based on the provided measurement information.

13. A method comprising:
obtaining at least one measurement information, wherein the measurement information represents at least one weight and/or size of a shipment deposited in a lockable measuring module; and
determining, at least partially based on the obtained measurement information, at least one shipping option for shipping the shipment.

14. The method according to claim 13, wherein the obtained at least one measurement information is obtained from the measuring module, from a mobile device or from a compartment installation and is provided at the measuring module before the obtaining.

15. The method according to claim 13, wherein the method further comprises:
obtaining further measurement information, wherein the further measurement information represents at least one size of the shipment deposited in the measuring module, wherein the further measurement information is at least partially based on at least one further measurement parameter of the shipment, wherein the at least one further measurement parameter of the shipment is captured by a camera unit of the compartment installation, and wherein determining at least one shipping option for shipping the shipment is at least partially based on the at least one measurement information and the further measurement information.

16. The method according to claim 13, wherein the method further comprises:
determining, at least partially based on the at least one shipping option and a user input, shipping information for shipping the shipment.

17. The method according to claim 16, wherein the shipping information indicates at least one shipping option selected from the at least one shipping option, and furthermore indicates a shipping cost amount of the at least one selected shipping option, and wherein the method in particular further comprises:
determining, at least partially based on the franking information obtained from the measuring module and the shipping cost amount of the selected shipping option, whether the shipment is sufficiently franked.

18. The method according to claim 13, wherein the method further comprises:
determining, at least partially based on the obtained at least one measurement information, a compartment of the compartment installation; and
causing the opening of the determined compartment of the compartment installation.

19. The method according to claim 1, wherein the measuring module comprises at least one sensor for detecting the at least one measurement parameter of the shipment, and wherein the at least one measurement parameter of the shipment is detected by the at least one sensor while the shipment is located in the measuring module.

20. The method according to claim 1, wherein the measuring module is a part of the compartment installation.

21. A computer program, comprising program instructions that cause a processor to perform and/or to control the method according to claim 1 when the computer program runs on the processor.

22. An apparatus, configured to perform and/or control the method according to claim 1 or comprising respective means for performing and/or controlling the steps of the method according to claim 1.

23. An apparatus according to claim 22, wherein the apparatus is a control unit of the measuring module.

24. An apparatus, configured to perform and/or control the method according to claim 13 or comprising respective means for performing and/or controlling the steps of the method according to claim 13.

25. An apparatus according to claim 24, wherein the apparatus is a control unit of the compartment installation or is the backend server.

26. A system comprising:
a first apparatus configured to perform and/or control a first method comprising:
causing the opening of a lockable measuring module;
obtaining at least one measurement parameter of a shipment deposited in the measuring module; and
providing, at least partially based on the obtained at least one measurement parameter, measurement information, wherein the measurement information represents at least one weight and/or size of the shipment deposited in the measuring module, and wherein at least one shipping option for shipping the shipment is determined at least partially based on the provided measurement information; or comprising respective means for performing and/or controlling the steps of the first method; and
a second apparatus configured to perform and/or control a second method comprising:
obtaining at least one measurement information, wherein the measurement information represents at least one weight and/or size of a shipment deposited in a lockable measuring module; and
determining, at least partially based on the obtained measurement information, at least one shipping option for shipping the shipment;
or the second apparatus comprising respective means for performing and/or controlling the steps of the second method.
